(19) United States
(12) Patent Application Publication
(10) Pub. No.: US 2004/0133492 A1
(43) Pub. Date: Jul. 8, 2004

(54) Method and apparatus for public information dynamic financial analysis

(76) Inventor: Markus Stricker, Zurich (CH)

Correspondence Address: J. D. Harriman II, COUDERT BROTHERS LLP, 23rd Floor, 333 South Hope Street, Los Angeles, CA, 90071, US

(21) Appl. No.: 10/664,531

(22) Filed: Sep. 17, 2003

Related U.S. Application Data
(60) Provisional application No. 60/413,361, filed on Sep. 25, 2002.

(51) Int. Cl. G06F 17/60

(52) U.S. Cl. 705/35

(57) ABSTRACT

Embodiments of the present invention are directed to a method and apparatus for public information dynamic financial analysis. In one embodiment, information needed to perform a PIDFA is retrieved from a database. Information not already in a useable format is automatically calculated from the information retrieved. In one embodiment, the information is retrieved by selecting a company from a list of companies for which sufficient information is publicly available. In one embodiment, after information needed to perform a PIDFA is retrieved from a database, a model of a company's assets and liabilities is created. In one embodiment, a company's assets are modeled by a bond model, a cash account model and/or an equities and other investments model. In one embodiment, a pseudo-random number generator is used to model realizations of risks. In one embodiment, many of simulations are run using the pseudo-random number generator for a simulation time period.

### PRIORITY INFORMATION

This application claims priority to U.S. provisional application 60/413,361 filed Sep. 25, 2002.

### BACKGROUND OF THE INVENTION

1. Field of the Invention

The present invention relates to the field of financial analysis, and in particular to a method and apparatus for public information dynamic financial analysis.

2. Background Art

One technique used to roughly assess a company's financial needs (e.g., reinsurance, asset portfolio allocation, etc.) is to perform a public information dynamic financial analysis (PIDFA). In a PIDFA, publicly available information (e.g., from quarterly or annual reports issued from a company to the public) is used to project a company's financial needs over a time period (e.g., the next five years). However, the information necessary to perform a PIDFA is time consuming to collect. Some of the required information is available in an immediately usable format; however, frequently, some required information must extracted from the publicly available information to be useful. Typically, this problem makes performing a PIDFA an inefficient, time consuming process. This problem can be better understood by a review of PIDFAs

PIDFAs

When performing a PIFDA, an analyst collects publicly available information on a company's assets and liabilities. Typically, this information is manually extracted from quarterly or annual reports from the company. A number of simulations are run to generate statistically likely realizations of the company's assets, liabilities and cash flows during a time period. Thus, a company can obtain a rough approximation of what its financial needs are for a period of time. A better approximation of a company's financial needs can be obtained from a dynamic financial analysis using non-public information, but an adviser recruiting a new client is less likely to have access to non-public information.

### SUMMARY OF THE INVENTION

Embodiments of the present invention are directed to a method and apparatus for public information dynamic financial analysis. In one embodiment, information needed to perform a PIDFA is retrieved from a database. Information not already in a useable format is automatically calculated from the information retrieved. In one embodiment, the information is retrieved by selecting a company from a list of companies for which sufficient information is publicly available.

In one embodiment, the information is not necessarily publicly available, but is user-accessible (e.g., through a subscription service that is not available to the general public). Portions of this description focus on publicly available information, but some embodiments of the invention make use of user-accessible information. One skilled in the art will understand, from the description of embodiments using public information, how to practice embodiments of the present invention using user-accessible information.

Information about companies in the database is periodically updated. In one embodiment, when the information is updated, the data for each company is automatically checked to determine whether sufficient information is present to perform a PIDFA. In one embodiment, if sufficient information is present for a company, that company is displayed in a list. In another embodiment, if a particular needed data item is not present in the database, an indication is made of which data item is not present. In one embodiment, the indication can be retrieved whenever a user desires to know which needed data item (or items) is not present in the database. In one embodiment, information may be added to the database manually. Thus, when a necessary data item is missing from the public information for a company, the data item can be manually entered to enable a PIDFA to be performed for the company.

In one embodiment, after information needed to perform a PIDFA is retrieved from a database, a model of a company's assets and liabilities is created. In one embodiment, a company's assets are modeled by a bond model, a cash account model and/or an equities and other investments model. In one embodiment, a pseudo-random number generator is used to model realizations of risks. In one embodiment, many (e.g., thousands) of simulations are run using the pseudo-random number generator for a simulation time period. These simulations are combined to produce a statistically likely result for the simulation time frame. In one embodiment, after the end of each time period (e.g., a year), assets and liability models are adjusted. In one embodiment, after the asset and liability models are adjusted, a simulation continues to run for a subsequent time period. In one embodiment, a simulation is performed over a five year period with adjustments performed at one year intervals.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of retrieving, for each company listed in the public information database, information needed to perform a DFA on the company in accordance with one embodiment of the present invention.

FIG. 2 is a flow diagram of the process of performing a PIDFA in accordance with one embodiment of the present invention.

FIG. 3 is a block diagram of the different operations that change the state of the portfolios during a cycle of a simulation in accordance with one embodiment of the present invention.

FIG. 4 is a block diagram of the dependencies between various indices in accordance with the present invention.

FIG. 5 is a block diagram of the computation steps for the loss process in accordance with one embodiment of the present invention.

### DETAILED DESCRIPTION OF THE INVENTION

The invention is a method and apparatus for public information dynamic financial analysis. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Automatic Retrieval of Necessary Data for PIDFA

In one embodiment of the present invention, there are two types of databases: a public information database and a user-accessible database. A public information database (or data source/data provider) contains publicly available data on a number of companies. In one embodiment, access to this database is free. In another embodiment, there is a charge to access the database.

In one embodiment, the information contained in the public information database includes financial & business figures, such as balance sheet and profit & loss items. In an example embodiment involving an insurance company, the public information database also contains premium & reserve figures for different lines of business.

In one embodiment, a user-accessible database contains information processed from the public information database for each company listed in the public information database for which sufficient information is available. This information serves as input for a DFA. In one embodiment, the user accesses the user-accessible database, selects one of the companies listed and performs a DFA on it. In one embodiment, for the purpose of this DFA, the user has the option of modifying some of the company's DFA input parameters extracted from the user-accessible database. The content of the user-accessible database is not affected. In one embodiment, when a data item is unavailable or unusable, a proxy for the data item is used instead.

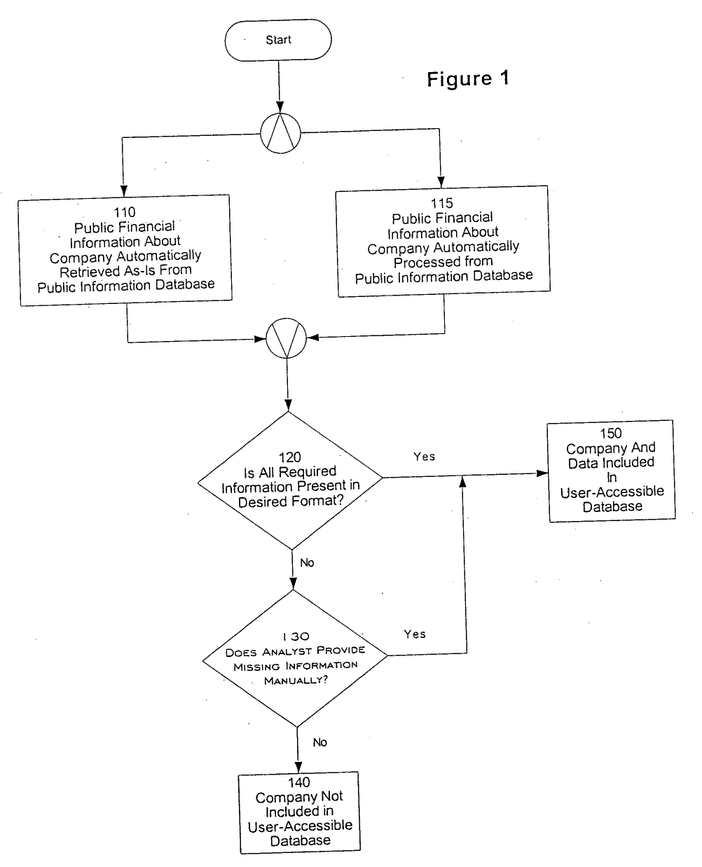

FIG. 1 illustrates the process of retrieving, for each company listed in the public information database, information needed to perform a DFA on the company in accordance with one embodiment of the present invention. At block 110, some of the information from the public information database is transferred as-is to the user-accessible database. At block 115, some of the information from the public information database are automatically combined and/or processed before being transferred to the user-accessible database. Blocks 110 and 115 are illustrates as being performed in parallel. However, blocks 110 and 115 are performed in series in either order in various embodiments. In still other embodiments, performance of blocks 110 and 115 is interleaved.

At block 120, it is determined whether all of the required information is present in the desired format (e.g., information on the company's bond holdings is grouped by holdings with identical relevant attributes rather than specific information on individual bond holdings). If it is determined that all of the required information is present in the desired format, at block 150, a PIDFA is performed. If it is determined that not all of the required information is present in the desired format, at block 130, it is determined whether an analyst provides the missing information or puts in the correct format (e.g., by aggregating individual bond holdings into an aggregate bond holding group having identical relevant attributes). If the analyst does provide the missing information the process continues at block 150. If the analyst does not provide the missing information, at block 140 this company is not listed in the user-accessible database.

In one embodiment, there are several public information databases. The multiple public information databases complete each other in terms of companies to be listed in the user-accessible database or in terms of data to be processed into the user-accessible database.

In one embodiment, the user-accessible database is updated as soon as a new version of the public information database is released. Another embodiment updates periodically and not necessarily as soon as a new version of the public information database is released. The same procedure as above applies.

Performing the PIDFA

In one embodiment, after information needed to perform a PIDFA is retrieved from the user-accessible database, a model of a company's assets and liabilities is created. In one embodiment, a company's assets are modeled by a bond model, a cash account model and/or an equities and other investments model. In one embodiment, a pseudo-random number generator is used to model realizations of risks. In one embodiment, many (e.g., thousands) of simulations are run using the pseudo-random number generator. These simulations are combined to produce a statistically likely result for the end of the simulation time period. In one embodiment, the pseudo-random number generator is given a seed value. When the same seed value is given more than once, the pseudo-random number generator produces reproducible pseudo-random numbers. Thus, a user can reproduce a previously performed PIDFA by entering the same public information and other values as well as the same seed for the pseudo-random number generator.

In one embodiment, after the end of each time period within a simulation, assets and liability models are adjusted. In one embodiment, after the asset and liability models are adjusted, the simulation continues to run for a subsequent time period. In one embodiment, a PIDFA is performed over a five year period with adjustments performed at one year intervals.

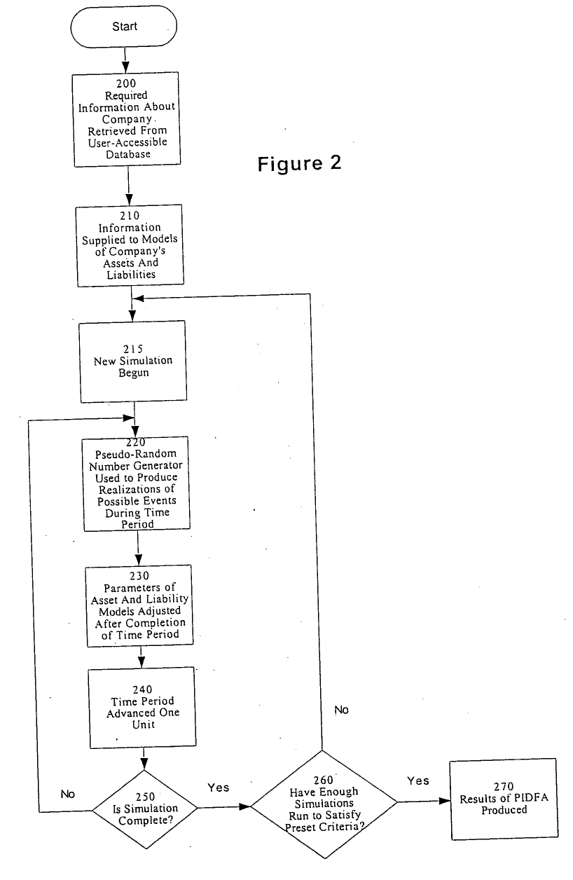

FIG. 2 illustrates the process of performing a PIDFA in accordance with one embodiment of the present invention. At block 200, required information about a company is automatically retrieved and/or extracted from a database of public information. At block 210, the information is supplied to models of the company's assets and liabilities. At block 215, a new simulation is begun. At block 220, a pseudo-random number generator is used to produce realizations of possible events (e.g., an insurance claim being made) during a time period. In one embodiment, the time period is one year, but other time periods (e.g., a month, a quarter, a day, etc.) are used in other embodiments.

At block 230, the parameters of the asset and liability models are adjusted after completion of the time period. For example, in one embodiment, a bond model is adjusted to account for bonds that were sold, matured or purchased during the time period. Similar adjustments are made to other modeled assets and liabilities. At block 240, the time period is advanced one unit (e.g., in a PIDFA covering a 5 year period with one year time periods, the time period advances a year). At block 250, it is determined whether the simulation is complete (e.g., finishing the sixth year of a simulation covering a 6 year period is complete). If the simulation is not complete, the process repeats at block 220. If the simulation is complete, at block 260, it is determined whether enough simulations have run to satisfy a preset criterion (e.g., desired numerical precision is reached). If enough simulations have run to satisfy a preset criterion, at block 270, the results of the PIDFA are produced. If not enough simulations have run to satisfy a preset criterion, the process repeats at block 215.

In one embodiment, the PIDFA is calculated using a web browser. A user selects a company from a list of available companies displayed in the browser and performs a PIDFA. The results are also displayed in the browser. In one embodiment, the user is able to save the results. In another embodiment, the user is not able to save the results, and the PIDFA is erased once the browser is closed.

Example Embodiment

The following is a description of an example embodiment of the present invention. The embodiment does not limit the scope of the invention, and variations of the invention are represented by other embodiments.

Model Structure and Components

One embodiment of the present invention contains an asset modelling component and a liability modelling component. These components model the underlying financial risks that a company is exposed to and each involves an external or market uncertainty and the translation into company exposures through investment strategy or business plan. In one embodiment, the two components feed a third component, the financial component. The third component translates the basic risks the company is exposed to into taxes, regulatory requirements, and accounting results.

In one embodiment, an accurate uncertainty model of the risks to which the company is exposed is developed and translated into an uncertainty model of the financial results of the company. This allows an accurate assessment of the financial risks of the company and provides a platform for adjusting management control variables, such as investment and reinsurance strategy, to improve the company's risk exposure.

In one embodiment, within each component are numerous parameters which are adjustable to create an accurate representation of the circumstances of a specified company. One embodiment of the present invention has an automatic calibration of these parameters based on public information. In prior art methods, it is necessary to manually perform extensive analysis of the company in order to determine these parameters.

One embodiment of the present invention uses pseudo-random numbers to determine individual realisations of the underlying risks or uncertainties. In a single cycle, pseudo-random numbers are used to progress a single simulation from one time period to the next. This process will be repeated for the simulation until it has reached then end of the requested simulation time frame (e.g., 3-5 years). Then, the entire process is repeated many times to create a large number of multiperiod simulations. This set of simulations is a model representation of all the possible financial outcomes and can be analysed with risk measures. Thus, the single cycle process is repeated for multiple time periods to advance a single simulation and a statistically large enough set of simulations are created for risk analysis.

In one embodiment, the time period for a cycle is one year. In other embodiments, the time period for a cycle is shorter than one year. In still other embodiment, the time period for a cycle is longer than one year.

Asset Model

In one embodiment, the asset model begins by modelling the risks of the capital markets, and then translates those into the exposures of the company. Since one embodiment uses a basic DFA model, the types of investment assets are limited to stocks, bonds, cash, and a generic “other” asset class, all within a single currency.

In one embodiment, control of the duration of the bond portfolio is provided by specification of a target average maturity of the bond portfolio. The embodiment models a portfolio of bonds, each with specific maturity, coupon, and price. The embodiment creates this portfolio based on the initial average maturity of the bond portfolio and the target maturity with the latter being applied to determine sales and purchases as the simulation proceeds.

Market Risk Models

One embodiment of the present invention uses a simple capital market model capable of reflecting fundamental market behaviour. It provides a complete model of interest rates with connections to inflation. Bond returns are determined directly from interest rate changes. Equity returns are correlated with bond returns. In one embodiment, the other investments class provides a simple constant return without any dynamics of the underlying values.

Interest Rates and Inflation

Elementary economic theory suggests that inflation and interest rates are not independent. In one embodiment, the model chosen is based on a two factor Hull-White interest rate model where the first factor is taken as the short rate and the second factors is interpreted as the (general) inflation rate.

The model is based on a two-dimensional linear stochastic differential equation for the development of inflation and short term interest rates. The term structure is defined as a certain function of these two factors as described further below.

Denote by rₜ and iₜ the short-term interest rate and the inflation at time t. Their evolution is defined by the stochastic differential equations

drₜ=(θ+(iₜ−μ)−arₜ)dt+σ₁dBₜ¹

diₜ=−b(iₜ−μ)dt+σ₂dBₜ². [0.1]

Here, (Bₜ¹, Bₜ²) denotes a two-dimensional Brownian motion with instantaneous correlation ρ. The parameter μ is the average level of inflation and b describes the mean reversion speed of the inflation. Therefore, according to the first equation, the short rate is mean reverting to a level dependent on the inflation and the parameter a determines the mean reversion speed. The parameter θ is assumed to be a constant which determines the long-term average short rate.

According to [0.1], inflation and interest rates are coupled due to the mean reverting level of the interest rate depending on inflation and the dependency of the Brownian motions driving the differential equations. Obviously, not all the typical characteristics observed in the fixed income markets can be reproduced. For instance, it should be noted that negative interest rates are possible with this model and the volatility of the long term rates turns out to be much smaller than the volatility of the short term rates. The latter behaviour is typical for equilibrium models.

Numerical Integration

In one embodiment, a discretization scheme for numerical integration of [0.1] is adopted. In order to evolve from t to t+1, refer to the Euler scheme given by

r_{t+β}_{ₖ₊₁}−r_{t+β}_{ₖ}=(θ+(i_{t+β}_{ₖ}−μ)−ar_{t+β}_{ₖ})·δt+σ₁\sqrt{δt}N_{t,k}¹

i_{t+β}_{ₖ₊₁}−i_{t+β}_{ₖ}=−b(i_{t+β}_{ₖ}−μ)·δt+σ₂\sqrt{δt}N_{t,k}² [0.2]

where (N_{t,k}¹, N_{t,k}²) is a sequence of standard Gaussian random variables with correlation ρ and {βₖ=k/M^{discr}, k=1, . . . , M^{discr}} defines the integration grid with uniform time steps δt=1/M^{discr}.

This discretised model is now easily simulated. Also, it is possible to estimate parameters of the discretised model given a sequence of discrete and equidistant observations. In one embodiment, a monthly basic step size is used.

Term Structure Modelling

For the continuous time two factor Hull-White-model under consideration, the (no arbitrage) price at time t of a unit cash flow occurring at time t+τ is of the form

Λₜ(τ)=A(τ)·exp(−B(τ)rₜ−C(τ)iₜ) [0.3]

The coefficients B and C are given by

$$\begin{matrix}B ( τ ) = \frac{1 - exp ( - a τ )}{a} \\ C ( τ ) = \frac{{b}^{′} exp ( - a τ ) - a exp ( - {b}^{′} τ ) + a - {b}^{′}}{{ab}^{′} ( a - {b}^{′} )}\end{matrix} \qquad [ 0.4 ]$$

where b′=b−λ₁ and λ₁ denotes a market price of risk parameter.

The coefficient A is much more complicated and related to the parameters a, b′, θ′=θ+λ₂, σ₁, σ₂, ρ (with λ₂ a second market price of risk parameter) by the expression

A(τ)=exp(−A1+A2+A3+A4+A5+A6) [0.5]

where,

A1=s₂²/(4(a−b′)²b′³exp(2b′τ))

A2=σ₂(b′ρσ₁+s₂)/(a(a−b′)′³exp(b′τ)

A3=σ₂(−(aρs₁)+b′ρσ₁+s₂)/(a(a−b′)²b′(a+b′)exp((a+b′)τ))

A4=(−a²ρθ′+ab′²θ′+ab′s₁²−b′²s₂+aρσ₁σ₂−2b′ρσ₁σ₂−s₂²)/(4a³(a−b′)²exp(2aτ))

A5=(−a²s₁²+2ab′s₁²−b′²s₁²+2aρσ₁σ₂−2b′ρσ₁σ₂−s₂²)/(4a³(a−b′)²exp(2aτ))

A6=(4a²b′³θ+4ab′⁴θ′−3ab′³s₁²−3b′⁴s₁²−4a²b′ρσ₁σ₂−8ab′²ρσ₁σ₂−6b′³ρσ₁σ₂−3a²s₂²−5ab′s₂²−3b′²s₂²−4a³b′³θ′τ−4a²b′⁴θ′τ+2a²b′³s₁²τ+2ab′⁴s₁²τ+4ab′³pσ₁σ₂τ+2a²b′s₂²τ+2ab′²s₂²τ)/(4a³b′³(a+b′))

In one embodiment, the conditional expectation for the price of a discount bond at time t+h given the information available at t is computed as follows.

E[Λₜ₊ₕ(τ)|ℑₜ]=Λₜ(τ)·E[exp(−B(τ)(rₜ₊ₕ−rₜ)−C(τ)(iₜ₊ₕ−iₜ))|ℑₜ]. [0.6]

Since the combined short rate and inflation rate process (rₜ, iₜ) is a two-dimensional Gaussian process, the conditional expectation on the right hand side actually is an expected value of a lognormally distributed random variable with parameters μ(t, h, τ) and σ(h, τ) so that

E[Λₜ₊ₕ(τ)|ℑₜ]=Λₜ(τ)·exp(μ(t, h, τ)+σ(h, τ)²/2). [0.7]

In an embodiment using a continuous time set-up with φₓ(h):=(1−exp(−xh))/x the parameters μ and σ are given by

$$μ ( t , h , τ ) = B ( τ ) \{ a {ϕ}_{a} ( h ) \cdot ( {r}_{t} - θ / a ) - ( \frac{a}{a - b} {ϕ}_{a} ( h ) - \frac{b}{a - b} {ϕ}_{b} ( h ) ) \cdot ( {i}_{t} - μ ) \} + C ( τ ) b {ϕ}_{b} ( h ) \cdot ( {i}_{t} - μ ) \qquad [ 0.8 ]$$

σ(h, τ)²=B(τ)²·[σ₁²−2σ₁σ₂ρ/(a−b)+σ₂²/(a−b)²]·φ₂ₐ(h)+{2B(τ)²·[σ₁σ₂ρ/(a−b)−σ₂²/(a−b)²]+2B(τ)C(τ)·[σ₁σ₂ρ−σ₂²/(a−b)]}·φ_{a+b}(h)+{B(τ)²σ₂²(a−b)²+2B(τ)C(τ)·[σ₂²/(a−b)]+C(τ)²σ₂²}·φ_{2b}(h) [0.9]

In one embodiment, the return of a discount bond is given by

Δ\hat{r}_{t,t+1}(τ)=(Λₜ₊₁(τ−1)−Λₜ(τ))/Λₜ(τ) [0.10]

and the conditional expectation of the bond return for the interval [t,t+1] given the information available at t is given by

E[Δ\hat{r}_{t,t+1}(τ)|ℑₜ]=(E[Λₜ₊₁(τ−1)|ℑₜ]−Λₜ(τ))/Λₜ(τ) [0.11]

where the conditional expectation on the r.h.s. is given by [0.7] with h=1.

Equity and Other Investment Index

In one embodiment, the equity index Iₜ^{(eq)} is modelled by a (piece-wise) geometric Brownian motion process. The evolution of the index is given by

Iₜ₊₁^{(eq)}=Iₜ^{(eq)}·LN₂(μ_{t,t+1}, σ^{(eq)}) with Iₜ_{₀}^{(eq)}=1 [0.12]

where LN₂(μ,σ) denotes a lognormally distributed random variable with parameters μ and σ. In one embodiment, when referring to LN₂ with index 2, the mean and standard deviation of the associated normally distributed random variable is used as a parameter.

One embodiment assumes that the time dependent expected (log-) return is equal to the expected long bond return for the time interval [t,t+1] given the information available at time t: E[Δr_{t,t+1}(\hat{τ})|ℑₜ] with a suitable term \hat{τ} (e.g. \hat{τ}=10y) plus a risk premium Δμ^{(eq,0)} plus a term depending on the actual bond return in the interval [t,t+1] so that it is represented by the formula

μ_{t,t+1}=ν^{eq}·E[Δ\hat{r}_{t,t+1}(\hat{τ})|ℑₜ]+Δμ^{(eq,0)}+ρ_{E-ΔR}·(Δ\hat{r}_{t,t+1}(\hat{τ})−E[Δ\hat{r}_{t,t+1}(\hat{τ})|ℑₜ]). [0.3]

A correlation between interest rate movements and stock market returns is introduced by the last term in [0.13].

In one embodiment, the dividend yield of the index is given by a constant denoted by δ^{(eq)}. In one embodiment, the above construction is applied for two indices, the “Equity” index, driving the value of the equity portfolio and the “Other Investments” index which influences the “Other Investments” portfolio. In one embodiment, the parameters for the equity index are specified in GUI (except for ν^{eq} which is set equal to ν^{eq}=1). In another embodiment, the “Other Investments” index parameters are fixed at trivial values:

ν^{oi}=0,Δμ^{(oi,0)}=0, ρₒᵢ=0, σ^{(oi)}=0. [0.14]

Asset Categories—Bonds

In one embodiment, a bond is characterised by the following quantities:

Its time to maturity τ, 1≦τ≦D^{bonds} where D^{bonds} is a fixed constant—here, we denote with τ the time to maturity at purchase date s. The time to maturity from the current time t will be denoted by a capital T and is related to τ by

T=Tₜ(τ,s)=τ−(t−s).

The nominal value N which is received from the issuer when the bond matures.

The coupon rate expressed as a percentage of the nominal value and denoted by γ.

The purchase year s in which the bond has been (or will be) purchased and the associated purchase value.

Finally, the lowest market value which is required for the strict lower of cost or market value principle used in some countries.

Therefore, in one embodiment, the smallest modelling unit in the portfolio corresponds in general to a collection of bonds with the same time to maturity and the same purchase year. At time t a model bond (τ,s) is characterised by the nominal value Nₜ(τ,s), the coupons rate γ(τ,s), the purchase value Vₜ^{(bond,cost)}(τ,s), the lowest market value Vₜ^{(bond,lowestM)}(τ,s), and the market value (current value) Vₜ^{(bond,M)}(τ, S).

Note that with this definition of a bond partial selling is allowed. As a consequence, this turns the nominal value Nₜ(τ,s) to a time-dependent quantity. In contrast, the coupons expressed as a percentage of the nominal value are not time-dependent. Such a modelling unit is termed a “bond.”

In one embodiment, the temporal distribution of cash flows within one year are not resolved. Instead, it is assumed that the coupons payments and the face value from maturing bonds are due at the end of the year. Similarly, one embodiment does not explicitly distinguish between interest accrued and interest paid.

Valuation

Different accounting standards require different valuation procedures. In the following, the definitions for the different concepts of “value” for a single “model” bond is given in accordance with one embodiment of the present invention. The corresponding value of the whole portfolio is obtained just by summing the contributions of the individual bonds.

In one embodiment, the purchase cost of the “bond” (τ,s) at time t is denoted by Vₜ^{(bond,cost)}(τ,s) which is obtained by reducing the purchase cost at time s by the intermediate sales since the purchase date. At time s the bond is bought at market value which is inferred from the term structure of interest rates. In one embodiment, the nominal value of the “bond” (τ,s) at time t is denoted by Nₜ(τ,s). In one embodiment, given the term structure of interest rates at time t (specified by the discount factors {Λₜ(τ),1≦τ≦D^{bonds}}) the market value of the bond (τ,s) at t is given by

$${V}_{t}^{( bond , M )} ( τ , s ) = {N}_{t} ( τ , s ) \cdot [ {Λ}_{t} ( τ - ( t - s ) ) + γ \cdot {\sum }_{u = 1}^{τ - ( t - s )} {Λ}_{t} ( u ) ] \qquad [ 0.1 ]$$

In one embodiment, the lower of cost or market value takes the minimum of the purchase cost and the current market value. To be specific:

Vₜ^{(bond,C-M)}(τ,s)=min(Vₜ^{(bond,lowestM)}(τ,s);V^{(bond,cost)}(τ,s)) [0.2]

In another embodiment, the strict lower of cost or market value takes the minimum of the purchase cost and the lowest market value. To be specific:

Vₜ^{(bond,SCM)}(τ,s)=min(Vₜ^{(bond,lowestM)}(τ, s); Vₜ^{(bond,cost)}(τ,s)) [0.3]

In one embodiment, the difference between purchase cost and nominal value is amortised as a premium over the period until maturity and is included as income in the profit and loss account. Therefore, for the bond (τ,s), the amortised cost value at t is given by

$${V}_{t}^{( bond , A C )} ( τ , s ) = {V}_{t}^{( bond , cost )} ( τ , s ) + \frac{t - s}{τ} ( {N}_{t} ( τ , s ) - {V}_{t}^{( bond , cost )} ( τ , s ) ) \qquad [ 0.4 ]$$

The accounting standard considered in one embodiment prescribes which notion of value is referred to as the book value finally reported in the balance sheet. The book value is denoted by Vₜ^{(bonds,book)}. Similarly, the value relevant for tax accounting is denoted by Vₜ^{(bonds,tax)}.

For the total portfolio values, the same symbols as above are used but omitting the bond parameters (τ,s). For instance, the amortised cost value or the nominal value of the portfolio are given by Vₜ^{(bond,AC)} and Nₜ, respectively.

Intermediate Accounts

In one embodiment, the intermediate accounts collect information about the bond portfolio which is needed for the production of the financial statements. To be specific, the intermediate account quantities comprise the following quantities:

Investment income cash flow I^{(bonds,cash)}

Amortisation gain I^{(bonds,amort)}

Realised gains R^{(bonds,gains)}

Depreciation X^{(bonds,depr)}

Unrealised gains Π^{(bonds,unrealGains)}

Cash from maturates and from sales of bonds C^{(bonds,sales)}

Cash invested in new bonds C^{(bonds,new)}

Basic Portfolio Operations

In accordance with one embodiment of the present invention, the effect of the portfolio operations is described on the level of the characterising quantities of bonds and leads to updates of the intermediate accounts.

In one embodiment, the portfolio is initialised at t₀ by loading the individual bonds with 1≦τ≦D^{bonds} and s≦t₀ characterised by the coupon rates γ(τ,s), the nominal values Nₜ_{₀}(τ,s), the market values Vₜ_{₀}^{(bond,M)}(τ,s), the purchase values Vₜ_{₀}^{(bond,cost)}(τ,s), and lowest market values Vₜ_{₀}^{(bond,lowestM)}(τ,s). While the portfolio initialisation is carried through once at the beginning of the simulation, the initial values for the intermediate accounts are set at the beginning of each time step.

In one embodiment, initial values for the hidden reserve and, if required by the accounting standard, for the revaluation are set.

Investment income cash flow I^{(bonds,cash)}=0

Amortisation gain I^{(bonds,amort)}=0

Realised gains R^{(bonds,gains)}=0

Depreciation X^{(bonds,depr)}=0

Unrealised gains Π^{(bonds,unrealGains)}=Vₜ^{(bonds,M)}−Vₜ^{(bonds,book)}.

Cash from maturates and from sales of bonds C^{(bonds,sales)}=0.

Cash invested in new bonds C^{(bonds,new)}=0

The operations described below can be carried out, in principle, at any instant of (simulation) time, once the initialisation of the bond portfolio and of the intermediate account has been processed.

Sales of Bonds

In one embodiment, sales of individual bonds are not possible. Only a percentage of the whole portfolio can be sold, so that the same percentage is applied to all individual model bonds. The basic parameter of a sales operation is the sales rate which is denoted by Ω. The impact on the characterising quantities is

Nominal value: Nₜ(τ,s)→(1−Ω)·Nₜ(τ,s).

Coupons rate. γ(τ,s) unchanged.

Purchase value: Vₜ^{(bond,cost)}(τ,s)→(1−Ω)·Vₜ^{(bond,cost)}(τ,s).

Lowest market value: Vₜ^{(bond,lowestM)}(τ,s)→(1−Ω)·Vₜ^{(bond,lowestM)(τ,s).}

Market (current) value: Vₜ^{(bond,M)}(τ,s)→(1−Ω)·Vₜ^{(bond,M)}(τ,s).

The update of the intermediate account is given by

Investment income cash flow: I^{(bonds,cash)}→I^{(bonds,cash)}.

Amortisation gain: I^{(bonds,amort)}→I^{(bonds,amort)}.

Realised gains: R^{(bonds,gains)}→R^{(bonds,gains)}+Ω·Π^{(bonds,unrealGains)}.

Depreciation: X^{(bonds,depr)}→(1−Ω)·X^{(bonds,depr)}.

Unrealised gains: Π^{(bonds,unrealGains)}→(1−Ω)·Π^{(bonds,unrealGains)}.

Cash from maturates and from sales of bonds C^{(bonds,sales)}→C^{(bonds,sales)}+Ω·V^{(bonds,M)}

where V^{(bonds,M)} is the market value of the bond portfolio before the sales operation.

Cash invested in new bonds: C^{(bonds,new)}→C^{(bonds,new)}.

Updating for a New Period

In one embodiment, the evolution of a bond by a time step Δt leads to a revaluation of the bond due to a new term structure of interest rates, cash from coupon payments and cash from maturing bonds.

The market value of a “bond” (τ,s) with t+Δt<τ+s (non-maturing bonds) changes by the amount

$$\begin{matrix}Δ {V}_{t + Δ t}^{( bond , M )} ( τ , s ) = {N}_{t} ( τ , s ) \{ {Λ}_{t + Δ t} ( τ - ( t + Δ t - s ) ) - \\ {Λ}_{t} ( τ - ( t - s ) ) \} + γ ( τ , s ) {N}_{t} ( τ , s ) \\ \{ {\sum }_{u = Δ t}^{τ - ( t + Δ t - s )} ( {Λ}_{t + Δ t} ( u ) - {Λ}_{t} ( u ) ) - {Λ}_{t} ( τ - ( t - s ) ) \}\end{matrix} \qquad [ 0.5 ]$$

On the other hand both, notional value and purchase are not changed provided that the bond is not maturing (t+Δt<τ+s). One embodiment does not account for credit risk. Hence,

Nominal value: Nₜ(τ,s)→Nₜ(τ,s).

Coupons rate. γ(τ,s) unchanged.

Purchase value: Vₜ^{(bond,cost)}(τ,s)→Vₜ^{(bond,cost)}(τ,s).

Market value: Vₜ^{(bond,M)}_{(τ,s)→V}ₜ^{(bond,M)(τ,s)+ΔV}_{t+Δt}^{(bond,M)}(τ,s)

The lowest market value is update according to: Vₜ^{(bond,lowestM)}(τ,s)→min(Vₜ^{(bond,lowestM)}(τ,s),V_{t+Δt}^{(bond,M)}(τ,s)).

In one embodiment, the intermediate account quantities change according to the following formulas. The values used in the formulas below, (N(τ,s),V^{(bond,book)}(τ,s),V^{(bond,cost)}(τ,s)), refer to the values of the bond just before the updating operation.

$$\begin{matrix}Investment income cash flow \text{:} \\ {I}^{( bonds , cash )} \to {I}^{( bonds , cash )} + {\sum }_{τ , s : Δ t \leq τ + s - t \leq {D}^{bonds}}^{} γ ( τ , s ) \cdot {N}_{t} ( τ , s ) . \\ Amortisation gain ( for amortised cost valuation ) \text{:} \\ {I}^{( bonds , amort )} \to {I}^{( bonds , amort )} + {\sum }_{τ , s : Δ t \leq τ + s - t \leq {D}^{bonds}}^{} \frac{1}{τ} ( N ( τ , s ) - {V}^{( bond , cost )} ( τ , s ) ) \\ Realised gains ( except for amortised cost valuation ) \text{:} \\ {R}^{( bonds , gains )} \to {R}^{( bonds , gains )} + {\sum }_{τ + s = t + Δ t}^{} ⌊ N ( τ , s ) - {V}_{t}^{( bonds , book )} ( τ , s ) ⌋ .\end{matrix}$$

Depreciation:

Xₜ^{(bonds,depr)}→Xₜ^{(bonds,depr)}+V_{t+Δt}^{(bonds,book)}−(Vₜ^{(bonds,book)}−Vₜ^{(bonds,book)}(T=1))

Unrealised gains:

$${Π}^{( bonds , unrealGains )} \to {Π}^{( bonds , unrealGains )} + {\sum }_{τ , s : Δ t \leq τ + s - t \leq {D}^{bonds}}^{} Δ {V}_{t + Δ t}^{( bond , M )} ( τ , s )$$

Previous book value:

Cash from maturates and from sales of bonds

$${C}^{( bonds , sales )} \to {C}^{( bonds , sales )} + {\sum }_{τ + s = t + Δ t}^{} N ( τ , s )$$

Cash invested in new bonds:

C^{(bonds,new)}→C^{(bonds,new)}.

Cash Invested in New Bonds

In one embodiment, the cash available for purchasing new bonds ΔC is split up in portions ΔC(τ) which are allocated to different maturates such that ideally a target maturity structure of the bond portfolio is achieved. This is defined by percentages

Γ₁, . . . , Γ_{D}_{^{bonds}} with

$${\sum }_{d = 1}^{{D}^{bonds}} {Γ}_{d} = 1$$

where Γ_{d} gives the percentage of total nominal value which has time to maturity of d years. The formula below, which gives the allocation of the cash for new bonds on the different maturates in accordance with one embodiment of the present invention, is based on the assumption that the bonds are purchased at PAR:

$$Δ C ( τ ) = l {\{ {Γ}_{d} \cdot ( N + Δ C ) - {\sum }_{s + {τ}^{′} = t + τ}^{} N ( {τ}^{′} , s ) \}}_{+} \qquad [ 0.6 ]$$

The notional values N, N(τ,s) are the values just before the purchase operation. The normalisation factor l defined such that the sum of the contributions ΔC(τ) gives the total ΔC. The nominal values of the new bonds are of the form

$$Δ N ( τ , t ) = Δ C ( τ ) / ( {Λ}_{t} ( τ ) + γ ( τ , t ) \cdot {\sum }_{u = 1}^{τ} {Λ}_{t} ( u ) ) \qquad [ 0.7 ]$$

where γ(τ,t) is the coupon rate. One embodiment assumes that these coupon rates are given by the PAR values

$$γ ( τ , t ) = ( 1 - {Λ}_{t} ( t ) ) / {\sum }_{u = 1}^{τ} {Λ}_{t} ( u ) \qquad [ 0.8 ]$$

Note that buying at PAR implies that ΔN(τ,t)=ΔC(τ). Thus, the purchase operation of buying new bonds at time t leads to introducing additional model portfolio entries with characteristics

Nominal value: ΔNₜ(τ,t).

Coupons rate. γ(τ,t).

Purchase value: Vₜ^{(bond,cost)(τ,t)=ΔC(τ).}

Market value: Vₜ^{(bond,M)}(τ,t)=ΔC(τ).

Lowest market value: Vₜ^{(bond,lowestM)}(τ,t)=ΔC(τ)

All the existing entries (s<t) remain unchanged.

In one embodiment, all the intermediate account quantities remain unchanged except for the “cash invested in new bonds” position which changes according to

Cash for new bonds: C^{(bonds,new)→C}^{(bonds,new)}+ΔC

In view of implementing asset-liability management strategies or for the computation of portfolio characteristics such as the duration, it is interesting to compute the projected future cash flows from the current portfolio in accordance with one embodiment of the present invention. For the portfolio hold at t, the cash received at t+τ from coupon payments and maturing bonds is given by

$${C}_{t}^{( bonds )} ( τ ) = {\sum }_{s = τ + t - {D}^{bonds}}^{t} {N}_{t} ( τ + ( t - s ) , s ) + {\sum }_{{τ}^{′} = τ}^{{D}^{bonds}} ( {\sum }_{s = {τ}^{′} + t - {D}^{bonds}}^{t} γ ( {τ}^{′} + ( t - s ) , s ) {N}_{t} ( {τ}^{′} + ( t - s ) , s ) ) \qquad [ 0.9 ]$$

One embodiment assumes to have a portfolio with an average bond maturity of five years (“initial average bond maturity”, \overline{D}^{initial}). In order to set up such a portfolio, the embodiment introduces as many different terms as necessary, each with identical weight, such that the required average maturity is obtained. To be specific, the embodiment distributes the total initial nominal value, Nₜ_{₀}, on different terms according to

Nₜ_{₀}(τ,t₀−1)=Nₜ_{₀}/(2·\overline{D}^{initial}−1) for τ=2, . . . , 2·\overline{D}^{initial}. [0.10]

At t₀ the bonds have times to maturity τ=1, . . . , 2·\overline{D}^{initial}−1. One embodiment assumes that the coupon rates for the bonds are all given by the initial yield of the bond portfolio:

γ(τ,t₀−1)=\overline{γ} for τ=2, . . . , 2·\overline{D}^{initial}. [0.11]

For the US, the total book value of the bonds as provided by the data source is interpreted as the amortised cost value which is, assuming PAR bonds, equal to the nominal value. Therefore,

Vₜ_{₀}^{(bond,cost)}(τ,t₀−1)=Nₜ_{₀}(τ,t₀−1) for τ=2, . . . , 2·\overline{D}^{initial}. [0.12]

and the initial market value is given by the initial term structure of interest rates as given by the interest rate model:

$${V}_{{t}_{0}}^{( bond , M )} ( τ , {t}_{0} - 1 ) = {N}_{{t}_{0}} ( τ , {t}_{0} - 1 ) \cdot ( {Λ}_{{t}_{0}} ( τ - 1 ) + γ ( τ , {t}_{0} - 1 ) {\sum }_{u = 1}^{τ - 1} {Λ}_{{t}_{0}} ( u ) ) \qquad [ 0.13 ]$$

again for τ=2, . . . , 2·\overline{D}^{initial}.

In one embodiment, the lowest market value is initialised at

Vₜ_{₀}^{(bond,lowestM)}(τ,t₀−1)=min(Vₜ_{₀}^{(bond,M)}(τ,t₀−1),Vₜ_{₀}^{(bond,cost)}(τ,t₀−1)) [0.14]

for τ=2, . . . , 2·\overline{D}^{initial}.

For the simulation period, one embodiment allows a user to enter the future average bond portfolio (\overline{D}^{future}) and the model allocates cash for new bonds as specified above (“cash invested in new bonds”) with a target maturity structure

Γ_{d}=1/(2·\overline{D}^{future}−1) for d=1, . . . , 2·\overline{D}^{future}−1. [0.15]

Equities and Other Investments

In one embodiment, both the Equity portfolio and the Other Investment portfolio are modelled by an index portfolio. The two investment categories are distinguished by the way of calibrating the portfolio, the valuation method adopted and in the way of defining the market index (“Equity market index” and “Other Investment index”). The following description only mentions “Equities.” In one embodiment, “Other Investments” are handled in exactly the same way.

In one embodiment, the market value of the equity portfolio is assumed to follow the stock market index. This means that the market value of the equity portfolio can be written as a multiple of the stock market index, i.e.

Vₜ^{(eq,M)}=Mₜ^{(eq)}·Iₜ^{(eq)} [0.16]

where Mₜ^{(eq)} is interpreted as the number of index certificates hold in the portfolio at time t.

Similar to the “bonds,” the equities are characterised by the year in which they are purchased. The smallest unit within the equity portfolio is then defined by:

the number of index certificates Mₜ^{(eq)}(s) included in the portfolio at time t which have been purchased in year s

the purchase price per index certificate purchased in year s and denoted by Ĩₛ^{(eq)}, s≦t. Note that if the equity portfolio would have strictly followed the (observable) market equity index in the past, the purchase price per index certificate would be given by the index Iₛ^{(eq)}, s≦t₀. For calibration issues we allow a somewhat more general parameterisation of the model, but set for the projection period Ĩₛ^{(eq)}=Iₛ^{(eq)} for s>t₀ where t₀ is the initial year.

Similar to the bonds, we carry forward the lowest index value, Iₛ^{(eq,lowest)}.

Valuation

In one embodiment, the purchase price of the equities purchased in year s is given by Vₜ^{(eq,cost)}(s)=Mₜ^{(eq)}(s)·Ĩₛ^{(eq)}. The purchase value of the whole portfolio is obtained by summing over past purchase years

$${V}_{t}^{( eq , cost )} = {\sum }_{s \leq t}^{} ( {M}_{t}^{( eq )} ( s ) \cdot {\tilde{I}}_{s}^{( eq )} \qquad [ 0.17 ]$$

In another embodiment, the market value is easily obtained as the number of index certificates multiplied by the current value of the equity market index:

$${V}_{t}^{( eq , M )} = ( {\sum }_{s \leq t}^{} {M}_{t}^{( eq )} ( s ) ) \cdot {I}_{t}^{( eq )} \qquad [ 0.18 ]$$

In yet another embodiment, the lower of cost or market value is given by

$${V}_{t}^{( eq , C - M )} = {\sum }_{s \leq t}^{} ( {M}_{t}^{( eq )} ( s ) \cdot min ( {I}_{t}^{( eq )} , {\tilde{I}}_{s}^{( eq )} ) ) . \qquad [ 0.19 ]$$

In one embodiment, the strict lower of cost or market value is given by

$${V}_{t}^{( eq , lowestM )} = {\sum }_{s \leq t}^{} ( {M}_{t}^{( eq )} ( s ) \cdot min ( {I}_{s}^{( eq , lowest )} , {\tilde{I}}_{s}^{( eq )} ) ) . \qquad [ 0.20 ]$$

In one embodiment, the accounting standard relevant for the company prescribes the notion of value to be used in the financial statements. This book value is denoted by Vₜ^{(eq,book)} and, similarly, the tax accounting value by Vₜ^{(eq,tax)}.

Intermediate Accounts

In one embodiment, the intermediate accounts collect information about the equity portfolio which is needed for the production of the financial statements. To be specific, the intermediate account quantities comprise the same quantities as used for the bond portfolio:

Investment income cash flow I^{(eq,cash)}

Amortisation gain I^{(eq,amort)}≡0

Realised gains R^{(eq,gains)}

Depreciation X^{(eq,depr)}

Unrealised gains Π^{(eq,unrealGains)}

Cash from sales of equities C^{(eq,sales)}

Cash invested in new equities C^{(eq,new)}

Basic Calculation Steps

In one embodiment, the portfolio at t₀ is initialised by loading the following quantities for the individual equities with s≦t₀:

Number of index certificates included in portfolio at t₀ and purchased in year s: {Mₜ_{₀}^{(eq)}(s)}.

Index history {Iₛ^{(eq)}} or {Ĩₛ^{(eq)}} that forms together with the number of index certificates a set of quantities that is consistent with the market values Vₜ_{₀}^{(eq)}(s), the purchase values Vₜ_{₀}^{(eq,cost)}(s) and the book values Vₜ_{₀}^{(eq,book)}(s).

Lowest market value index certificate is given by {Iₛ^{(eq,lowest)}=Vₜ_{₀}^{(eq,lowestM)}(s)/Mₜ_{₀}^{(eq)}(s)}.

In one embodiment, while the portfolio initialisation is carried through once at the beginning of the simulation, the initial values for the intermediate accounts are set at the beginning of each time step.

Investment income cash flow I^{(eq,cash)}=0.

Amortisation gain I^{(eq,amort)}≡0

Realised gains R^{(eq,gains)}=0

Depreciation: X^{(eq,depr)}=0

Unrealised gains

available for sales equities: Π^{(eq,unrealGains)}=Vₜ_{₀}^{(eq,M)}−Vₜ_{₀}^{(eq,cost)}

lower of cost or market value: Π^{(eq,unrealGains)}=Vₜ_{₀}^{(eq,M)}−Vₜ_{₀}^{(eq,C-M)}

and similarly for the strict lower of cost or market value.

Cash from sales of equities C^{(eq,sales)}=0.

Cash invested in new equities C^{(eq,new)=}0.

Sales of Equities

In one embodiment, sales of individual equity portfolio entries is not possible. In another embodiment, only a percentage of the whole portfolio can be sold so that the same percentage is applied to all individual portfolio entries. The basic parameter of a sales operation is the sales rate which is denoted by Ω.

In one embodiment, the impact on the characterising quantities is

Number of index certificates: Mₜ^{(eq)}(s)→(1−Ω)·Mₜ^{(eq)}(s).

Index history is not modified.

Lowest index level not modified.

In one embodiment, the update of the intermediate account is given by

Investment income cash flow: I^{(eq,cash)}→I^{(eq,cash)}.

Amortisation gain: I^{(bonds,amort)}≡0.

Realised gains: R^{(eq,gains)}→R^{(eq,gains)+Ω·Π}^{(eq,unrealGains)}.

Depreciation: X^{(eq,depr)}−(1−Ω)·X^{(eq,depr)}.

Unrealised gains: Π^{(eq,unrealGains)}→(1−Ω)·Π^{(eq,unrealGains)}.

Cash from sales of equities C^{(eq,sales)}→C^{(eq,sales)}+Ω·V^{(eq,M)}

where V^{(eq,M)} is the market value of the equity portfolio before the sales operation.

Cash invested in new equities: C^{(bonds,new)}→C^{(bonds,new)}.

Updating for a New Year

In one embodiment, the evolution of an equity portfolio entry by a time step t→t+Δt leads to a revaluation due to a new equity index level and cash from dividend payments. The number of index certificates (per equity portfolio entry) is not changed and the index history is extended by one new entry, the current I_{t+Δt}^{(eq)}. The market value of an equity portfolio entry changes according to

ΔV_{t+Δt}^{(eq,M)}(s)=\tilde{V}_{t+Δt}^{(eq,M)}(s)−\hat{V}ₜ^{(eq,M)}(s)=\hat{M}ₜ^{(eq)}(s)·(I_{t+Δt}^{(eq)}−Iₜ^{(eq)}). [0.21]

Thus, the lowest index level is changed according to

Iₜ^{(eq,lowest)}(s)→I_{t+Δt}^{(eq,lowest)}(s)=min(Iₜ^{(eq,lowest)}(s);I_{t+Δt}^{(eq)}(s)). [0.22]

In one embodiment, the lower of cost or market value evolves according to

$$\begin{matrix}Δ {V}_{t + Δ t}^{( eq , C - M )} = {V}_{t + Δ t}^{( eq , C - M )} - {V}_{t}^{( eq , C - M )} \\ = ( {\sum }_{s \leq t}^{} {M}_{t}^{( eq )} ( s ) \cdot ( min ( {I}_{t + Δ t}^{( eq )} , {\tilde{I}}_{s}^{( eq )} ) - min ( {I}_{t}^{( eq )} , {\tilde{I}}_{s}^{( eq )} ) ) )\end{matrix} \qquad [ 0.23 ]$$

[0.23]

The intermediate accounts are transformed according to the rules:

Investment income cash flow: I^{(eq,cash)}→I^{(eq,cash)}+δ^{(eq)}·V^{(eq,M)}

where V^{(eq,M)} is the market value of the equity portfolio before the update operation.

Amortisation gain: I^{(eq,amort)}≡0.

Realised gains: R^{(eq,gains)}→R^{(eq,gains)}.

Depreciation:

lower of cost or market value: X^{(eq,depr)}→X^{(eq,depr)}+ΔV_{t+Δt}^{(eq,C-M)}.

Unrealised gains:

$$\begin{matrix}available for sales equities \text{:} \\ {Π}_{t}^{( eq , unrealGains )} \to {Π}_{t}^{( eq , unrealGains )} + {\sum }_{s \leq t}^{} Δ {V}_{t + Δ t}^{( eq , M )} ( s ) . \\ lower of cost or market value \text{:} \\ {Π}_{t}^{( eq , unrealGains )} \to {Π}_{t}^{( eq , unrealGains )} + {\sum }_{s \leq t}^{} Δ {V}_{t + Δ t}^{( eq , M )} ( s ) - Δ {V}_{t + Δ t}^{( eq , C - M )}\end{matrix}$$

Cash from sales of equities: C^{(eq,sales)}→C^{(eq,sales)}

Cash invested in new equities: C^{(bonds,new)}→C^{(bonds,new)}.

Purchase of New Equities

In one embodiment, given the cash available for new equities, ΔC, and the current equity index level Iₜ^{(eq)} it is easy to compute the associated number of index certificates that can be purchased:

ΔMₜ^{(eq)}(t)=ΔC/Iₜ^{(eq)} [0.2]

From the characterising quantities of the portfolio only the number of index certificates purchased at t is increased by the above amount, index history and lowest index levels remain unchanged.

In one embodiment, the intermediate accounts are updated according to

Investment income cash flow: I^{(eq,cash)}→I^{(eq,cash)}

Amortisation gain: I^{(eq,amort)}≡0

Realised gains: R^{(eq,gains)→R}^{(eq,gains)}.

Depreciation: X^{(eq,depr)}→X^{(eq,depr)}.

Unrealised gains: Π^{(eq,unrealGains)→Π}^{(eq,unrealGains)}.

Cash from sales of equities C^{(eq,sales)}→C^{(eq,sales)}

Cash invested in new equities: C^{(bonds,new)}→C^{(bonds,new)}+ΔC.

For the calibration of the initial portfolio, one embodiment assumes that the portfolio has been purchased in the year t₀−1. The index level at t₀ is defined to be identical to one so that

the number of index certificates included in the portfolio at t₀ is

Mₜ_{₀}^{(eq)}(t₀−1)=Vₜ_{₀}^{(eq,M)}/Iₜ_{₀}^{(eq)}=Vₜ_{₀}^{(eq,M);} [0.25]

the index level at purchase date t₀−1 is given by

Ĩₜ_{₀}₋₁^{(eq)}=(Vₜ_{₀}^{(eq,M)}−Πₜ_{₀}^{(eq,unrealGains)})/Vₜ_{₀}^{(eq,M)}. [0.26]

For the other investments portfolio the same calibration procedure is adopted in one embodiment:

the number of index certificates included in the portfolio at t₀

Mₜ_{₀}^{(OI)}(t₀−1)=(Vₜ_{₀}^{(OI,cost)}+Πₜ_{₀}^{(OI,unrealGains)})/Iₜ_{₀}^{(eq)}=Vₜ_{₀}^{(eq,cost)}+Πₜ_{₀}^{(OI,unrealGains)}; [0.27]

the index level at purchase date t₀−1 is given by

Ĩₜ_{₀}₋₁^{(eq)}=Vₜ_{₀}^{(eq,cost)}/(Vₜ_{₀}^{(eq,cost)}+Πₜ_{₀}^{(OI,unrealGains)}) [0.28]

Cash Account In one embodiment, the characterising quantities of the cash deposit is just the amount included in this account. It is denoted by Vₜ^{(CA)}. The cash amount reported in the balance sheet by the end of the year is denoted by Vₜ^{(CA)}. Short-term fixed income securities that are eventually included in the cash deposit are not separately treated in one embodiment. These are valued at market valued.

Initialisation of the Structure

In one embodiment, the initial portfolio at t₀ is initialised by loading Vₜ_{₀}^{(CA)}. In one embodiment, while the portfolio initialisation is carried through once at the beginning of the simulation, the initial values for the intermediate accounts are set at the beginning of each time step.

Investment income cash flow I^{(CA,cash)}=0.

Amortisation gain I^{(CA,amort)}≡0

Realised gains R^{(CA,gains)}≡0

Depreciation: X^{(CA,depr)}≡0

Unrealised gains Π^{(CA,unrealGains)}≡0

Cash from sales of “cash”: C^{(CA,sales)}=0.

Cash allocated to the cash deposit: C^{(CA,new)}=0.

“Sales” of Cash

In one embodiment, “sales” of cash is used in the sense of just taking cash from the cash deposit and making it available for another usage. The sales operation is characterised by specifying a sales rate Ω. The cash amount changes according to

Vₜ^{(CA)}→(1−Ω)·Vₜ^{(CA)}

and the intermediate account quantities are transformed as follows:

Investment income cash flow I^{(CA,cash)}→I^{(CA,cash)}.

Amortisation gain I^{(CA,amort)}≡0

Realised gains R^{(CA,gains)}≡0

Depreciation: X^{(CA,depr)}≡0

Unrealised gains Π^{(CA,unrealGains)}≡0

Cash from sales of ‘cash’: Cₜ^{(CA,sales)→C}ₜ^{(CA,sales)}+Ω·Vₜ^{(CA)}.

Cash allocated to the cash deposit: Cₜ^{(CA,new)}→Cₜ^{(CA,new)}.

Update of Cash Account

In one embodiment, the evolution of the cash account by a time step t→t+Δt only leads to a payment of a short interest income. The basis for calculating that income position is composed of appropriate percentages of cash deposit as reported in the balance sheet, the net premium written in the period under consideration and the dividend to paid out to shareholders for the last financial year. Therefore, the income is of the form

ΔI_{t+Δt}^{(CA,cash)}=r_{t+Δt}^{(cash)}·[ [symbol] ^{CA}·Vₜ^{(CA)}+ [symbol] ^{NPW}·Pₜ^{(W,net)}+ [symbol] ^{DIV}·Dₜ] [0.29]

where we use the year average short rate

r_{t+Δt}^{(cash)}=(rₜ+r_{t+Δt})/2 [0.30]

where rₜ is the short rate at the end of year t. Hence for the intermediate accounts, we obtain

Investment income cash flow Iₜ^{(CA,cash)}→Iₜ^{(CA,cash)}+ΔI_{t+Δ}^{(CA,cash)}.

Amortisation gain I^{(CA,amort)}≡0

Realised gains R^{(CA,gains)}≡0

Depreciation: X^{(CA,depr)}=0

Unrealised gains Π^{(CA,unrealGains)}≡0

Cash from sales of ‘cash’: C^{(CA,sales)}→C^{(CA,sales)}.

Cash allocated to the cash deposit: C^{(CA,new)}→C^{(CA,new)}.

Cash Allocated to Cash Account

In another embodiment, allocating cash ΔC to the cash deposit changes the cash amount to

Vₜ^{(CA)}→Vₜ^{(CA)}+ΔC

and the intermediate accounts are changed according to

Investment income cash flow Iₜ^{(CA,cash)}→Iₜ^{(CA,cash)}.

Amortisation gain I^{(CA,amort)}≡0

Realised gains R^{(CA,gains)}≡0

Depreciation: X^{(CA,depr)}≡0.

Unrealised gains Π^{(CA,unrealGains)}≡0

Cash from sales of ‘cash’: C^{(CA,sales)}→C^{(CA,sales)}.

Cash allocated to the cash deposit: C^{(CA,new)}→C^{(CA,new)}+ΔC.

In one embodiment, the initial cash position Vₜ_{₀}^{(CA)} is taken from the data source.

Asset Management Strategy

In one embodiment, the following basic asset management operations are applied in the modelling of one year:

Reallocation of assets at the beginning of the year.

Update for updated risk factors (including income and cash from maturates): t→t+1.

Baseline sales (at the end of the year).

Sales for balancing liquidity (at the end of the year).

Allocation of cash for new assets, purchase of new investments (at the end of the year).

In one embodiment, in order to have a desired asset mix from the beginning of the year, a reallocation of assets is often necessary. The desired asset mix is expressed in terms of market values. According to the notation introduced above, the market value of the investments at the beginning of year t+1 is given by the quadruple

(Vₜ^{(bonds,M)}, Vₜ^{(eq,M)}, Vₜ^{(others,M)}, Vₜ^{(CA)}) [0.1]

with its sum denoted by Vₜ^{(M)}=Vₜ^{(bonds,M)}+Vₜ^{(eq,M)}+Vₜ^{(others,M)}+Vₜ^{(CA)}. The desired asset mix is specified by percentages (αₜ₊₁^{bonds}, α₁^{eq}, αₜ₊₁^{others}, αₜ₊₁^{CA}) with αₜ₊₁^{bonds}+ₜ₊₁^{eq}+αₜ₊₁^{others}+αₜ₊₁^{CA}=1. For the cash flows to be exchanged between the asset categories we obtain

ΔC^{(X,buy)}=(αₜ₊₁^{X}Vₜ^{(M)}−Vₜ^{(X,M)})+C^{(X,sales)}=−(αₜ₊₁^{X}Vₜ^{(M)}−Vₜ^{(xx,M)}). [0.2]

where “X” stands for “bonds,” “eq,” “others” or “CA.”

In accordance with one embodiment of the present invention, in each portfolio a sales operation is carried through characterised by the sales rate:

Ω^{(X)}=min(1,C^{(X,sales)}/Vₜ^{(X,M)}) for “X”=“bonds,” “eq,” “others,” “CA” [0.3]

Afterwards, the cash ΔC^{(X,buy)} is invested in the portfolio “X” with “X”=“bonds,” “eq,” “others,” “CA.” As described above, the sales operations will lead to additional cash from sales and to realised gains and the purchase operation to additional cash invested in new investments. In one embodiment, the user specifies the target asset mix which is assumed to be fixed over the simulation horizon.

In one embodiment, the portfolios are updated for the evolution of the risk factors (interest rates, equity index, other investment index) by one time interval (e.g., one year): t→t+Δt. By the update, the cash income and the cash from maturates are collected. Additionally, revaluation reserve, realization gains (from maturates), amortization gain and the depreciation expense are modified.

In one embodiment, for some investment portfolios, a basic turnover results due to tactical portfolio transactions. These operations will change the cash from sales, the realization gains, the unrealized gains and it turns eventual depreciation expenses into realized losses. In one embodiment, the user specifies (constant) baseline sales rates associated with the above mentioned basic asset turnover.

In another embodiment, the cash available (from operating cash flow, maturing assets and sales of assets) is not sufficient to settle the claims payments or to pay interest on debt. In one embodiment, that liquidity is balanced by selling additional assets. As a result, sales rates Ω^{(X,CB)} are specified and sales operations are applied to the portfolio.

In one embodiment, when cash is available for new investments at the end of the year, it is allocated to the different asset categories according to the target asset mix given by (αₜ₊₁^{bonds}, αₜ₊₁^{eq}, αₜ₊₁^{others}, αₜ₊₁^{CA}). This defines the percentage of total market value of investments held in the particular investment category. The market value of total investments at the end of year t+1 is given by

Vₜ₊₁^{(M)}=(Vₜ₊₁^{(bonds,M)}+\tilde{V}ₜ₊₁^{(eq,M)}+\tilde{V}ₜ₊₁^{(others,M)}+\tilde{V}ₜ₊₁^{(CA)})+ΔC^{(new)} [0.7]

where the \tilde{V}'s denote the values of the portfolios just before the purchase operation and ΔC^{(new)} is the cash available for new investments. Therefore, the cash to be invested in asset category X is then given by

ΔCₜ₊₁^{(X,new)}=gₜ₊₁·max(0;αₜ₊₁^{X}·Vₜ₊₁^{(M)}−Vₜ₊₁^{(X,M)}) [0.8]

where \tilde{V}ₜ₊₁^{(x,M)} denotes the sum \tilde{V}ₜ₊₁^{(M)}=\tilde{V}ₜ₊₁^{(bonds,M)}+\tilde{V}ₜ₊₁^{(eq,M)}+\tilde{V}ₜ₊₁^{(others,M)}+\tilde{V}ₜ₊₁^{(CA)}. The factor gₜ₊₁ is used to assure that ΔCₜ₊₁^{(bonds,new)}+ΔCₜ₊₁^{(eq,new)}+ΔCₜ₊₁^{(others,new)}+ΔCₜ₊₁^{(CA,new)}≡Cₜ₊₁^{(new)}.

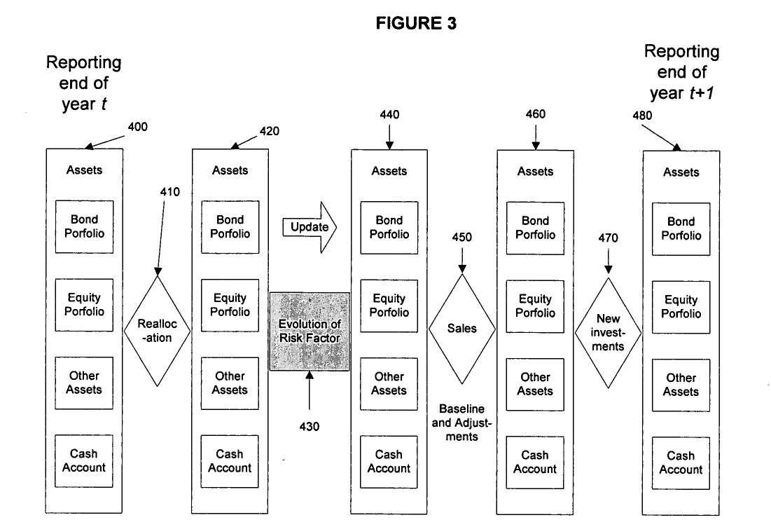

FIG. 3 illustrates the different operations that change the state of the portfolios during a cycle of a simulation in accordance with one embodiment of the present invention. The assets 300 reported at the end of year t undergo a reallocation 310 to produce a new asset structure 320. Then, an evolution of risk factors 330 is performed, yielding asset structure 340. Sales 350 are made to yield asset structure 360, and new investments 370 are made to produce the assets 380 reported at the end of year t+1.

Investment Expenses, Other Items

In one embodiment, non-technical expenses include overhead costs and expenses of the investment department. The non-technical expenses are modelled as a percentage of the market value of all investments, i.e.

Xₜ^{non-tech}=εₜ^{non-tech}·Vₜ₋₁^{(M)} [2.3.1]

where εₜ^{non-tech} is a non-technical expense ratio and Vₜ^{(M) is the sum of the market values of all investments, i.e.}

Vₜ^{(M)}=Vₜ^{(bonds,M)}+Vₜ^{(eq,M)}+Vₜ^{(others,M)}+Vₜ^{(CA)} [2.3.2]

In one embodiment, the non-technical expense ratio are related to inflation (e.g. wage inflation). Another embodiment treats it as a deterministic time series. The calibration procedure is designed such that this time series is consistent with expected future inflation. Transaction costs of investment activities actually reduce the cash flow from investment activities. However, one embodiment ignores transaction costs.

In one embodiment, in order to constitute consistency with the published profit and loss statement at the initial year, the positions not explicitly modelled are condensed in the quantity “other income” denoted by Oₜ. One embodiment assumes that this income is constant over the simulation horizon (Oₜ=Oₜ_{₀}), and that it is received as a cash flow in every year t. One embodiment interprets other income as other income including charges and investment expenses so that we set εₜ^{non-tech}=0 and take Oₜ_{₀} as provided by the data source.

Liability Model

In one embodiment, the liability portfolio consists of two lines of business, property and casualty. Both are identical in structure. For convenience, in one embodiment, a further line of business (“Other”) is introduced in order to include lines of business that can neither be mapped to property nor to casualty (e.g. aggregate write-ins). However, the cash flows from the “Other” line of business are projected at zero value and the balance sheet entries (unpaid claims reserve) are projected at the initial constant level in one embodiment.

In one embodiment, the liability model is not independent of the asset model. For example, liability claims are impacted by inflation. In one embodiment, the modeling of a single line of business consist of two parts: The simulation of the risk factors and suitable indices per line of business and the modeling of their impact on the liability portfolio and the financials. However, this separation is less natural than in the asset model, since it is more difficult to model the risk factors separate from specific portfolio information.

In the following description of a model line of business in accordance with one embodiment of the invention, our notation does not differentiate different lines of business. However, different calibration parameters and different initialization data will be used for the different lines of business. In another embodiment, the different lines of business and the associated risk factors are assumed to be independent except for a stochastic dependency introduced by claims inflation. In other embodiments with a more detailed model where more lines of business are mapped further dependencies are taken into consideration.

Risk Factors/Indices for a Line of Business

In one embodiment, similar to the asset model, the volatility of the liabilities is modelled by introducing risk factors. Some risk factors are only treated as deterministic indices. One embodiment formulates scenarios for the development of these risk factors with the help of these indices. In another embodiment, indices are used to describe expected systematic changes in the market and of the portfolio. The indices are sometimes interpreted as a result of management policy.

The interpretation is not always unique. One embodiment introduces an expense ratio index that models changes in the expense ratio. The expense ratio is driven by general inflation or wage inflation, but is also reduced by cost cutting strategies implemented in the company. Therefore, the expense ratio index incorporates both aspects.

Claims Inflation

In one embodiment, the claims inflation iₜ^{(CI)} is assumed to be related to general inflation iₜ. The most simple relationship is given by a linear relation of the form

iₜ^{(CI)}=a·iₜ+(b_{t+σ}^{(CI)}·εₜ^{(CI)}) [0.1]

where a is the sensitivity parameter with respect to general inflation, bₜ is a time-dependent but deterministic parameter which allows to model systematic drifts not related to general inflation and the last term constitutes an error term with mean zero and standard deviation σ^{(CI)}. In one embodiment, the random variable εₜ^{(CI)} is taken as a standard normally distributed random variable (with mean zero and standard deviation one). In one embodiment, different values for the parameters will be used for different lines of business.

In one embodiment, the claims inflation index is defined by

Iₜ^{(CI)}=max[(1+iₜ^{(CI)})·Iₜ₋₁^{(CI)};ε_{reg}]with Iₜ_{₀}^{(CI)}=1 [0.2]

and where ε_{reg} is some suitable regularisation. It is used to scale the calendar year claims payments and the loss reserve level. One embodiment supposes a relation between premium and claims inflation. One embodiment uses the following parameter choices:

a=1, bₜ=0, σ^{(CI)}=0. [0.3]

This implies that in the embodiment, claims inflation is equal to general inflation.

Premium Index

In one embodiment, the premium index is given by a deterministic time series times a correction due to past claims inflation:

$${I}_{t}^{( P )} = {I}_{t}^{( P , 0 )} \cdot {( \frac{{I}_{t - Δ}^{( CI )}}{{I}_{{t}_{0} - Δ}^{( CI )}} )}^{D} with {I}_{{t}_{0}}^{( P )} = {I}_{{t}_{0}}^{( P , 0 )} = 1 \qquad [ 0.4 ]$$

and where υ≧0 is a sensitivity parameter and Δ is a time lag. This index describes the development of the gross premium written according to

Pₜ^{(W,gross)}=Iₜ^{(P)}·Pₜ_{₀}^{(W,gross)}=Iₜ^{(P)}Iₜ₋₁^{(P)}·Pₜ₋₁^{(W,gross)},t₀ the initial time. [0.5]

In one embodiment, changes in volume, premium rates and past inflation rates determine the evolution of the index. Therefore, elements of the management policy and elements driven by the market developments are implicitly included in the index.

In one embodiment, the deterministic contribution Iₜ^{(P,O)} is specified by a constant growth rate so that

Iₜ^{(P,O)}=(1+g)·Iₜ^{(P,O)} [0.6]

where g can be modified by the user. In another embodiment, the “earned premium” index is defined by

Iₜ^{(P,earned)}=(1−ω^{(P)})Iₜ^{(P,O)}(I_{t-Δ}^{(CI)}/Iₜ_{₀}_{-Δ}^{(CI)})^{v}+ω^{(P)}Iₜ₋₁^{(P,O)}(I_{t-Δ-1}^{(CI)}/Iₜ_{₀}_{-Δ-1}^{(CI)})^{v}. [0.7]

Loss Ratio Index

In one embodiment, the loss ratio index Iₜ^{(LR)} describes systematic changes in the average gross accident year loss ratio and enters the equation for the gross accident year losses according to

Lₜ^{(gross)}=Iₜ^{(CI)}·Iₜ^{(LR)}·ζₜ·Pₜ^{(earned,gross)} [0.8]

where t₀ is the initialisation year, ζₜ is the random variable describing the accident year loss ratio on an as-if basis for the initial year portfolio and Pₜ^{(earned,gross)} is the earned premium. Note that according to the above formula, market price changes implicit in the premium Pₜ^{(earned,gross)} would also have an impact on the accident year losses—as long as these are not compensated in the loss ratio index. In the definition of the loss ratio index Iₜ^{(LR)} this dependency of premium on past claims inflation is cancelled out:

$${I}_{t}^{( LR )} = \frac{{I}_{t}^{( exposure )}}{( {I}_{t}^{( P , earned )} + {ϵ}_{reg} )} \qquad [ 0.9 ]$$

where Iₜ^{(exposure)}=Iₜ^{(LR,O)}·((1−ω^{(P)})Iₜ^{(P,O)}+ω^{(P)}Iₜ₋₁^{(P,O)}). [0.10]

and ε_{reg} denotes the regularisation parameter. The index Iₜ^{(LR,O)} is described by a deterministic time series and typically should compensate for company specific elements in pricing strategy (Iₜ^{(P,O)}). The parameter ω^{(P)} describes the unearned premium provisions as a fixed percentage of the premium written. In order to have perfect cancellation of any dependency of the accident year losses on past claims inflation for year t₀+1 one embodiment claims that Γₜ_{₀}^{(P,gross)}=ω^{(P)}Pₜ_{₀}^{(written,groos)}. With Iₜ_{₀}^{(LR,O)}=1 it follows that that Iₜ_{₀}^{(LR)}=1.

In one embodiment, the impact of claims inflation during the claims payments period is not included in the accident year losses. Changes in the index are driven by changes in premium margins and factors that drive the average gross accident year losses such as the average claims frequency per risk (but other than expected claims inflation).

One embodiment describes the loss ratio index Iₜ^{(LR,O)} by a trend parameter π so that Iₜ₊₁^{(LR,O)}=Iₜ^{(LR,O)}+π. By this definition, the additive change in the accident year loss ratio is proportional to π. However, the calendar year loss ratio which is prepared as a key figure generally is not. In one embodiment, the parameter if is modifiable by the user and is initially set equal to zero.

Expense Ratio Index

In one embodiment, the expense ratio index denoted by Iₜ^{(X)} describes the development of the expense ratio. The associated expenses include administrative expenses, claims settlement expenses and broker commissions. Similar to the procedure adopted in the definition of the loss ratio index, one embodiment compensates for the impact of past claims inflation on premium when computing the calendar year expenses. However, the embodiment does not assume an explicit dependency on current inflation. Therefore, the expense ratio index is defined by

$${I}_{t}^{( X )} = {I}_{t}^{( X , 0 )} \cdot {( \frac{{I}_{t - Δ}^{( CI )}}{{I}_{{t}_{0} - Δ}^{( CI )}} )}^{- v} . \qquad [ 0.11 ]$$

where Iₜ^{(X,0)} is a deterministic series which implicitly includes the impact of general inflation on an average basis and, in one embodiment, of cost cutting plans or efficiency gains in the sales network. In another embodiment, expenses do not change due to changes in premium rates other than the ones inferred from past claims inflation. Therefore, changes in premium rates (implicit in Iₜ^{(P,O)}) are consistently absorbed in the definition of Iₜ^{(X,O)}.

The deterministic part of the expense ratio index is, similar to the loss ratio index, specified by a trend parameter. In one embodiment, the trend parameter is introduced according to Iₜ₊₁^{(X,O)}=Iₜ^{(X,O)}+χ/ε where ε is the as-if expense ratio for the initial state of the company. The annual change in the (calendar year) expense ratio is proportional to the trend parameter χ.

As-If Accident Year Loss Ratio

In one embodiment, the as-if accident year loss ratio ζ₁ is the major driving seed for the volatility of accident year losses. In the as-if ratio, no correction for claims inflation nor for the loss ratio trend is considered. In one embodiment, the ratio is composed of two parts, a “ground-up” loss contribution and a large loss contribution. Accordingly, the as-if accident year loss ratio is of the form

ζₜ=ζₜ^{(ground-up)}+ζₜ^{(large)}. [0.12]

In one embodiment, the ground-up contribution to the (as-if) accident year loss ratio is made up by many small claims occurring in the accident year. One embodiment assumes that the portfolio is large enough and that the individual claims diversify well within the portfolio. Consequently, the associated distribution of yearly aggregate claims is “well-shaped.” Another embodiment assumes ζ₁^{(ground-up)} to be lognormally distributed with average l₀^{(ground-up)} and volatility σ₀^{(ground-up)}. In one embodiment, for each accident year an independent realisation of the random variable ζ₁^{(ground-up)} is generated. By using a fixed volatility, one embodiment ignores potential improvements in diversification when the underlying exposure grows.

One embodiment considers two different types of large losses contributing to the as-if loss ratio:

Single large claims covered by single insurance contracts, e.g. large third party liability claims that are not triggered by one single “event.” The embodiment attaches the label “single” to this kind of losses.

Many rather small claims covered by many insurance contracts but triggered by one event, e.g. many motor hull claims caused by a hail event. The embodiment refers to these losses with the label “cumul.”

One embodiment assumes for single losses that the exposure index describes the change in the average number of claims while the average severity is assumed to be changed only by claims inflation. For cumul losses, the average number of loss events is assumed to be constant and the average severity scales with the exposure index and the claims inflation index. In both cases, the embodiment applies a frequency-severity modelling approach which consists of the following two steps:

First, the number of claims or event losses, Nₜ, is drawn as a Poisson distributed random variables:

Nₜ∝Poisson(λ(t)). [0.13]

Second, according to this number of claims/event losses independent identically distributed and suitably scaled claims/event loss sizes are generated which obey a truncated Pareto distribution:

Xₜ^{(k)}∝Paretoₓ_{ₘₐₓ}₍ₜ₎(α, x₀(t)) for 1≦k≦Nₜ. [0.14]

The parameters used in the generation of the frequency and the severity of the losses are summarised in the table below:

| | ‘single’ | ‘cumul’ |
|---|---|---|
| Average loss frequency | λ(t) = λ · I₁^{(exposure)} | λ(t) = λ |
| Pareto shape parameter | α | α |
| Attachment point | x₀(t) = x₀ | x₀(t) = x₀ · I₁^{(exposure)} |
| Cut-off parameter | xₘₐₓ(t) = xₘₐₓ | xₘₐₓ(t) = xₘₐₓ · I₁^{(exposure)} |

The definition of the cumulative Pareto distribution adopted in one embodiment is given by

$$F ( x ) = \frac{1 - {( {x}_{0} ( t ) / x )}^{α}}{1 - {( {x}_{0} ( t ) / {x}_{max} ( t ) )}^{α}} for {x}_{0} ( t ) \leq x < {x}_{max} ( t ) . \qquad [ 0.15 ]$$

and F(x)=0 for x≦x₀(t) and F(x)=1 for x≧xₘₐₓ(t).

The large claims contribution to the as-if loss ratio is then given by

$${ζ}_{t}^{( large )} = \frac{1}{{I}_{t}^{( exposure )}} \cdot {\sum }_{j = 1}^{{N}_{t}} {X}_{t}^{( j )} . \qquad [ 0.16 ]$$

In view of modelling the impact of reinsurance, one embodiment keeps book about the individual severities.

In one embodiment, the ground-up and the large loss contributions are understood to include allocated loss adjustment expenses (ALAE). Unallocated loss adjustment expenses (ULAE) are assumed to be included in the expenses. In one embodiment, for the casualty line of business the “single” interpretation is adopted whereas for property the “cumul” loss concept is used. In another embodiment, the parameters λ, α, x₀ are specifiable by the user.

In yet another embodiment, the cut-off parameter is defined such that the usual Pareto distribution is cut off at a cumulated probability of 1-10⁻⁶.

Calendar Year Shocks

In one embodiment, the volatility of the technical result reported per calendar year is not only driven by the stochastic accident year losses. Typically, the loss development is again stochastic due to the uncertainty in the timing in the size of the final loss burden. One embodiment uses a simplified model for this uncertainty by introducing calendar year shocks. These calendar year shocks affect both the calendar year claims payments and the changes in the reserves so that additional volatility is introduced to the incurred claims per calendar year. In one embodiment, calendar year shocks are modeled by multipliers of the form

Iₜ^{(cal)}=LN(μₜ^{(cal)},σₜ^{(cal)}) [0.17]

where LN(μ,σ) denotes a lognormal random variable with average and standard deviation μ and σ, respectively. By setting the parameter μₜ^{(cal)} to a value different from one, systematic excess or deficiency in reserves are modeled in one embodiment.

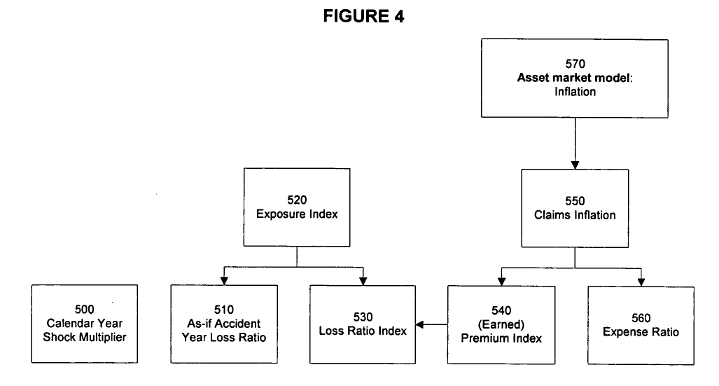

FIG. 4 illustrates the dependencies between various indices in accordance with the present invention. The calendar year shock multiplier 400 is independent of the other indices. As-if accident year loss ratio 410 is dependent on exposure index 420. Loss ration index 430 is dependent on both exposure index 420 and (earned) premium index 440. The (earned) premium index 440 is dependent upon claims inflation 450. Similarly, expense ration index 460 is dependent upon claims inflation 450. Likewise, claims inflation 450 is dependent upon the asset market model inflation value 470.

Impact on Line of Business

In one embodiment, with the help of the premium index, the gross written premium is projected to future years:

$${P}_{t + 1}^{( written , gross )} = {P}_{t}^{( written , gross )} \cdot \frac{{I}_{t + 1}^{( P )}}{{I}_{t}^{( P )}} = {P}_{{t}_{0}}^{( written , gross )} \cdot {I}_{t + 1}^{( P )} . \qquad [ 0.1 ]$$

One embodiment does not distinguish written premium from booked premium. The unearned premium provision Πₜ₊₁^{(P,gross)} is taken as a fixed percentage of gross written premium (ω^{(P)})_{acc}; i.e.

(Πₜ₊₁^{(P,gross)})_{acc}=(ω^{(P)})_{acc}·Pₜ₊₁^{(written,gross)}. [0.2]

The gross earned premium Pₜ₊₁^{(earned,gross)} differs from gross written premium by the yearly change in the gross unearned premium provision; hence

Pₜ₊₁^{(earned,gross)}=Pₜ₊₁^{(written,gross)}−[(Πₜ₊₁^{(P,gross)})_{acc}−(Πₜ^{(P,gross)})_{acc}] [0.3]

In one embodiment, the net earned premium is given by

Pₜ₊₁^{(earned,net)}=(1−qₜ₊₁)·Pₜ₊₁^{(earned,gross)}−Pₜ₊₁^{(ced,NP)} [0.4]

where qt+1 is the quota ceded to the reinsurers under proportional reinsurance and Pₜ₊₁^{(ced,NP)} is the premium paid for non-proportional reinsurance in year t+1. In one embodiment, the net unearned premium provision is defined by

(Πₜ₊₁^{(P,net)})_{acc}=(Πₜ₊₁^{(P,gross)})_{acc}·ρₜ₊₁^{(n.y. ret-level)}. [0.5]

where ρₜ₊₁^{(n.y.ret-level)} is the expected retention level of year t+2 given the information available at the end of year t+1. In one embodiment, the net written premium needed for the (net) technical cash flow is then computed according to

Pₜ₊₁^{(written,net)}=Pₜ₊₁^{(earned,net)}+[(Πₜ₊₁^{(P,net)})_{acc}−(Πₜ^{(P,net)})_{acc}]. [0.6]

The expected retention level for year t+2 is defined by

$${ρ}_{t + 1}^{( n . y . ret - level )} = ( 1 - {q}_{t + 2} ) \cdot [ 1 - {ϕ}_{t + 2} \cdot {P}_{t + 1}^{0} ( {d}_{t + 2} , {c}_{t + 2} ) \cdot {I}_{t + 1}^{( LR )} \cdot \frac{{I}_{t + 1}^{( CI )}}{{I}_{{t}_{0}}^{( CI )}} ] \qquad [ 0.7 ]$$

where Pₜ₊₁⁰ and φₜ₊₁ are discussed below. In one embodiment, only information about the future reinsurance program and about its pricing is used, but no information about the future development of the indices is anticipated.

In one embodiment, the initial written and unearned premium are specified by data from the data provider. Total gross and net written premium, net unearned premium and the percentual distribution of gross premium written by line of business αₚᵣₒₚ, α_{cas}, αₒₜₕₑᵣ are taken from the data source. With the following formulas the initial quantities as used in one embodiment are defined:

(Pₜ_{₀}^{(written,gross)})^{X}=α_{X}·(Pₜ_{₀}^{(written,gross)})^{total}

(Pₜ_{₀}^{(written,net)})^{X}=α_{X}·(Pₜ_{₀}^{(written,net)})^{total}

(Πₜ_{₀}^{(P,net)})_{stat,GAAP}^{X}=α_{X}·(Πₜ_{₀}^{(P,net)})^{total} [I]

where (Πₜ_{₀}^{(P,net)f})^{total} is received from the data source.

(Πₜ_{₀}^{(P,gross)})_{stat,GAAP}^{X}=(Πₜ_{₀}^{(P,net)})_{stat,GAAP}^{X}/(ρₜ_{₀}^{n.y.ret-level})^{X}

where (ρₜ_{₀}^{n.y.ret-level})^{X}=(1−qₜ_{₀}₊₁)·(1−φₜ_{₀}₊₁·Pₜ_{₀}⁰(dₜ_{₀}₊₁,cₜ_{₀}₊₁))

(ω_{X}^{(P)})_{stat,GAAP}=(Πₜ_{₀}^{(P,gross)})_{stat,GAAP}^{X}/(Pₜ_{₀}^{(written,gross)})^{X}

(ω_{X}^{(P)}_{USTax}=(1−ω₁)·(ω_{X}^{(P)})_{stat,GAAP}, ω₁ introduced in chapter 0.

(ω_{X}^{(P)})_{ec}=0 [II]

In one embodiment, the quantities in [I] are specified by the user (“Initial State”) and the quantities in [II] are then computed according to these GUI values.

Expenses

In one embodiment, expenses are modelled by multiplying gross premium written with the ratio trended by the expense ratio index introduced above:

$${X}_{t + 1}^{( gross , tech )} = ϵ \cdot \frac{{I}_{t + 1}^{( X )}}{{I}_{{t}_{0}}^{( X )}} \cdot {P}_{t + 1}^{( written , gross )} \qquad [ 0.8 ]$$

where ε is the as-if expense ratio for the initial year t₀. In one embodiment, the expenses are composed of broker commissions and acquisition costs, administrative expenses and unallocated claims settlement expenses (ULAE). As a consequence, ULAE are paid out immediately in the first development year while the ALAE are run off together with the losses. In another embodiment, deferred acquisition costs are modelled as a percentage of the net unearned premium provisions,

(Πₜ₊₁^{(DAC)})_{acc}=κ·(Πₜ₊₁^{(P,net)})_{acc}. [0.9]

Deferred acquisition costs are shown under US-GAAP on the balance sheet as an asset net of deferred reinsurance commissions. Changes in deferred acquisition costs are reported in the US-GAAP underwriting result.

In one embodiment, the net underwriting expenses are obtained after subtraction of the reinsurance commissions and profit participations. In one embodiment, profit participations are not modelled, and the reinsurance commissions are determined by a reinsurance provision rate πₜ₊₁. The portion of the gross underwriting expenses covered by the reinsurers is then given by

Xₜ₊₁^{(ceded,tech)}=πₜ₊₁·qₜ₊₁·Pₜ₊₁^{(earned,gross)} [0.10]

Then, the net underwriting expenses are computed by taking the difference of gross underwriting expenses minus ceded underwriting expenses.

In one embodiment, the expense ratio ε is constructed from industry average ratios and takes into account the company specific business split (measured in terms of gross written premium). In another embodiment, the deferred acquisition cost ratio κ is chosen to be κ=0.2 for property and for casualty.

Accident Year Losses

In one embodiment, according to the two contributions to the as-if accident year loss ratio we write

$$\begin{matrix}{L}_{t + 1}^{( gross )} = \frac{{I}_{t + 1}^{( CI )}}{{I}_{{t}_{0}}^{( CI )}} \cdot {I}_{t + 1}^{( LR )} \cdot ( {ζ}_{t + 1}^{( ground \text{-} up )} + {ζ}_{t + 1}^{( large )} ) \cdot {P}_{t + 1}^{( earned , gross )} \\ = {L}_{t + 1}^{( gross , ground \text{-} up )} + {L}_{t + 1}^{( gross , large )}\end{matrix} \qquad [ 0.11 ]$$

The two contributions are treated differently when computing the impact of reinsurance. One embodiment considers two different forms of reinsurance, quota share and excess of loss covers. The many small claims summed up in the ground-up loss are assumed by one embodiment not to exceed the deductible of the non-proportional reinsurance cover. Consequently, the ground-up claims are only affected by the quota share treaty. The portion ceded is then given by

Lₜ₊₁^{(ced,ground-up)}=qₜ₊₁·Lₜ₊₁^{(gross,ground-up)}. [0.12]

In contrast, in one embodiment, the large claims or event losses are eventually ceded under both proportional and non-proportional reinsurance—as long as they exceed the deductible of the excess of loss cover. The part which is ceded to the reinsurers is given by

$${L}_{t + 1}^{( ced , large )} = {q}_{t + 1} \cdot {L}_{t + 1}^{( gross , large )} + ( 1 - {q}_{t + 1} ) \cdot min ( ( {n}_{t + 1} + 1 ) \cdot {c}_{t + 1} ; {\sum }_{j = 1}^{{N}_{t + 1}} min ( {c}_{t + 1} ; max ( 0 ; {X}_{t + 1}^{( j )} \cdot \frac{{I}_{t + 1}^{( CI )}}{{I}_{{t}_{0}}^{( CI )}} - {d}_{t + 1} ) ) ) \cdot \frac{{I}_{t + 1}^{( LR )}}{{I}_{t + 1}^{( exposure )}} \cdot {P}_{t}^{( earned , gross )} \qquad [ 0.13 ]$$

where dₜ denotes the deductible, cₜ the cover and nₜ the number of reinstatements, which are defined on a as-if accident year loss ratio basis. In one embodiment, the definition of the cover does not include adjustments for (accident year by accident year) claims inflation nor to the loss ratio trend. However, since the net claims payments are deduced from the net accident year loss and since claims inflation is accounted for in the claims payments process one embodiment tacitly assumes the indexation clause to hold. One embodiment assumes that the additional premium for reinstatements are already included in Pₜ₊₁^{(ced,NP)}.

In one embodiment, the net accident year loss is then given by

Lₜ₊₁^{(net)}=Lₜ₊₁^{(gross)}−(Lₜ₊₁^{(ced,ground-up)}+Lₜ₊₁^{(ced,large)}) [0.14]

and

Lₜ₊₁^{(ced)}=Lₜ₊₁^{(ced,ground-up)}+Lₜ₊₁^{(ced,large)} [0.15]

Claims Payments and Reserving

In one embodiment, the loss caused in accident year s (“accident year loss”) is paid out in the years s, s+1, . . . , s+D−1 so that the claims are paid over a period of D years. The way the claims are paid out largely determines the outstanding claims provisions of accident year S. One embodiment makes the following assumptions:

The claims of a given accident year are paid out in accordance with a pattern of the form

(\tilde{λ}₁, . . . , \tilde{λ}_{D}) with 0≦\tilde{λ}_{d}≦1 and \tilde{λ}_{D}=1 [0.15]

where \tilde{λ}_{d} specifies the percentage of outstanding claims to be paid out in development year d. In particular, the embodiment assumes that this pattern is non-stochastic and that it is the same for each accident year. For simplicity, the embodiment assumes that the pattern (\tilde{λ}₁, . . . , \tilde{λ}_{D}) is specified by two parameters \tilde{λ}ᵢₙᵢₜᵢₐₗ, \tilde{λ}_{ongoing} according to

\tilde{λ}₁=\tilde{λ}ᵢₙᵢₜᵢₐₗ, \tilde{λ}_{d}=\tilde{λ}_{ongoing} for 2≦d<D.

For convenience, the embodiment sometimes refers to the transformed pattern given by

λ₁=\tilde{λ}₁

λ_{d}=λ_{d-1}+(1−λ_{d-1})·\tilde{λ}_{d}, 2≦d≦D [0.16]

However, in order to introduce some volatility in the loss development process, the embodiment introduces calendar year shocks that will impact the incurred claims for the past accident years.

The impact of non-proportional reinsurance on the claims payment process is not explicitly modelled in the embodiment so that the claims paid in year d as a percentage of the accident year loss is the same, before and after reinsurance.

The outstanding claims provisions are built per accident year and are taken proportional to the outstanding claims in the embodiment. The proportionality factors depend on parameters 0<≦ε₁, . . . , ε_{D-1}<1. Thus, they depend on the development year.

New Accident Year

The way to generate the accident year loss Lₜ₊₁^{(x)} where the “x” stands for “gross” or “net” is described in accordance with one embodiment of the present invention above. In accordance with the payment pattern, the claims paid in the first year are given by

ΔC_{t+1,t+1}^{(x)}=\tilde{λ}₁·Lₜ₊₁^{(x)} [0.17]

The remaining part which is not yet paid out (“claims outstanding”) is given by

ΔL_{t+1,t+1}^{(x)}=(1−\tilde{λ}₁)·Lₜ₊₁^{(x)} [0.18]

The accident year losses Lₜ₊₁^{(x)} are introduced on a claims inflation basis of year t+1.

Past Accident Years

In one embodiment, for a past accident year s (s=t−D+2, . . . , t) the claims outstanding at the end of year t is modified due to claims inflation and calendar year shocks. To be more specific, one embodiment defines the modified claims outstanding by

$$Δ {\hat{L}}_{s , t}^{( x )} = Δ {L}_{s , t}^{( x )} \cdot {I}_{t + 1}^{( c al )} \cdot \frac{{I}_{t + 1}^{( CI )}}{{I}_{t}^{( CI )}} = Δ {L}_{s , t}^{( x )} \cdot {I}_{t + 1}^{( c al )} \cdot ( 1 + {i}_{i + 1}^{( CI )} ) . \qquad [ 0.19 ]$$

Then, the claims paid in calendar year t+1 for accident year s and the claims outstanding at the end of year t+1 are easily obtained as

ΔC_{s,t+1}^{(x)}=\tilde{λ}ₜ₊₂₋ₛ·Δ\hat{L}_{s,t}^{(x)}, ΔL_{s,t+1}^{(x)}=(1−\tilde{λ}ₜ₊₂₋ₛ)·Δ\hat{L}_{s,t}^{(x)}. [0.20]

By just applying the calendar year shock multipliers to the gross and the net outstanding claims in exactly the same way, the embodiment assumes that additional claims associated with these shocks are ceded with the same fixed ceding ratio for the accident year considered.

Reserving

Often, insurance companies use actuarial techniques used to estimate the ultimate claims for a given accident year. One embodiment assumes that the ultimate loss burden for accident year s is known by the end of (calendar) year s except for the impact of claims inflation and calendar year shocks occurring during loss development. The nominal reserves set up by the end of year t+1 for accident year s≦t+1 is taken proportional to the outstanding claims at year t+I. The quantities

$${Ψ}_{s , t + 1}^{( x )} ( d ) = Δ {L}_{s , t + 1}^{( x )} \cdot \frac{( {λ}_{t + 2 - s + d} - {λ}_{t + 2 - s + d - 1} )}{( 1 - {λ}_{t + 2 - s} )} \qquad [ 0.21 ]$$

corresponds to the portion of the current outstanding loss due in d years. One embodiment refers to the payout pattern in the form (λ₁, . . . , λ_{D}). The statutory reserve for accident year s is then given by

$${( {Π}_{s , t + 1}^{( outst , x )} )}_{statut} = \frac{1}{1 - {ϵ}_{t + 2 - s}} \cdot {\sum }_{d = 1}^{D - ( t + 2 - s )} {Ψ}_{s , t + 1}^{( x )} ( d ) \frac{\hat{E} ⌊ {I}_{t + d + 1}^{( CI )} \vert {𝔍}_{t + 1} ⌋}{{I}_{t + 1}^{( CII )}} . \qquad [ 0.22 ]$$

In one embodiment, the first quotient is introduced to model systematic profits or losses during run-off. The last correction term in the sum is added due to expected future claims inflation \overline{i} which is assumed to be constant over time and non-random. In another embodiment, the economic outstanding loss reserve reserves is given by

$${( {Π}_{s , t + 1}^{( outst , x )} )}_{ec} = \frac{1}{1 - {ϵ}_{t + 2 - s}} \cdot {\sum }_{d = 1}^{D - ( t + 2 - s )} {Ψ}_{s , t + 1}^{( x )} ( d ) \cdot {( 1 + \overline{i} )}^{d} \cdot {Λ}_{t + 1} ( d ) . \qquad [ 0.23 ]$$

where Λₜ₊₁(d) denotes the term structure of discount factors.

For the tax value of the outstanding losses, one embodiment uses a similar formula as above with the discount factors Λₜ₊₁(d) replaced by

$${Λ}_{t + 1}^{tax} ( d ) = \frac{1}{{( 1 + {r}_{t + 1}^{( tax )} )}^{d}} \qquad [ 0.24 ]$$

For the US model one embodiment uses the current 5y zero bond yield as the discount rate rₜ^{(tax)}. In one embodiment, the contributions of all accident years are summed up in order to obtain total claims payments (by lob) in calendar year t+1 and the total outstanding loss reserve at the end of year t+1. In another embodiment, the incurred claims reported in the income statement of the financial year t+I are given by

Cₜ₊₁^{(claims,gross/net)}+([Πₜ₊₁^{(outst,gross/net)}]_{acc}−[Πₜ^{(outst,gross/net)}]_{acc}) [0.25]

where, for instance, for the statutory income the embodiment sets acc=stat. In this embodiment, the volatility of incurred claims is driven by the volatility of the accident year loss Lₜ₊₁^{(x)} including the volatility of the as-if accident year loss ratio and the volatility of claims inflation for year t+1; the volatility introduced by the calendar year shocks; the volatility of the claims inflation in year t+1 affecting the losses caused in past accident years; and eventually volatility introduced by using fluctuating interest rates in computing a discounted value of the reserves.

Initialisation at t₀

In one embodiment, the process is initialised with the outstanding claims of the different accident years at t₀, ΔL_{s,t}_{₀}^{(gross)}, ΔL_{s,t}_{₀}^{(net)} with t₀−D+1≦s≦t₀. One embodiment calculates these different portions assuming that the past accident year losses have developed in accordance with the specified claims payment patterns; constant accident year loss ratios and a constant business growth rate in the past; the same constant reserving inflation rate implicit in the outstanding loss estimates that is used for future calendar years; and a zero reserve attenuation pattern.

For the default calibration, one embodiment sets

$$\begin{matrix}Δ {L}_{s , {t}_{0}}^{( net , X )} = \frac{1}{N} {θ}_{s}^{X} ( {g}_{P , past}^{X} , i = 0 ) \cdot {Π}_{{t}_{0}}^{( outst , net )} & [ 0.26 ] \\ where & \\ {θ}_{s}^{X} ( g , i ) = \frac{1 - {λ}_{{t}_{0} - s + 1}^{X}}{{( 1 + g )}^{{t}_{0} - s}} \cdot {\overline{l}}_{X}^{past} {P}_{{t}_{0} , X}^{( written , net )} \cdot & [ 0.27 ] \\ {\sum }_{u = 1}^{D - ( {t}_{0} - s + 1 )} \frac{{λ}_{{t}_{0} - s + 1 + u}^{X} - {λ}_{{t}_{0} - s + u}^{X}}{1 - {λ}_{{t}_{0} - s + 1}^{X}} \cdot {( 1 + i )}^{u} ; & \\ N = {\sum }_{X = prop , cas} ( {\sum }_{s \leq {t}_{0}} {θ}_{s}^{X} ( {g}_{P , past}^{X} , {i}_{current}^{( res , X )} ) ) ; & [ 0.28 ]\end{matrix}$$

i_{current}^{(res,X)}=μ and μ is the long-term average inflation rate assumed in the default calibration of the interest rate and inflation model;

the constant accident year loss ratio \overline{l}_{X}^{past} assumed in the past is equal to the average ground-up loss ratio assumed for the future in the default calibration;

and there is no contribution of the “other” line of business included in the total outstanding claims reserve at t₀.

The net outstanding claims provisions by the lob of one embodiment is then given by

$${( {Π}_{{t}_{0}}^{( oust , net )} )}_{statut}^{X} = {\sum }_{s \leq {t}_{0}} Δ {L}_{s , {t}_{0}}^{( net , X )} \cdot {θ}_{s} ( {g}_{P , past}^{X} , {i}_{current}^{( res , X )} ) / {θ}_{s} ( {g}_{P , past}^{X} , i = 0 ) \qquad [ 0.29 ]$$

and the gross outstanding claims reserve is estimated by

$$Δ {L}_{s , {t}_{0}}^{( gross , X )} = Δ {L}_{s , {t}_{0}}^{( net , X )} \cdot \frac{{( {P}_{{t}_{0}}^{( written , gross )} )}^{X}}{{( {P}_{{t}_{0}}^{( written , net )} )}^{X}} . \qquad [ 0.30 ]$$

In one embodiment, once the user makes changes to user interface quantities, the outstanding losses per accident year are set equal to

$$\begin{matrix}Δ {L}_{s , {t}_{0}}^{( net , X )} = \frac{1}{{N}^{X}} {\tilde{θ}}_{s}^{X} ( {g}_{P , past}^{X} , i = 0 ) \cdot {( {Π}_{{t}_{0}}^{( outst , net )} )}^{X} & [ 0.31 ] \\ where & \\ {\tilde{θ}}_{s}^{X} ( g , i ) = \frac{1 - {λ}_{{t}_{0} - s + 1}^{X}}{{( 1 + g )}^{{t}_{0} - s}} \cdot {\sum }_{u = 1}^{D - ( {t}_{0} - s + 1 )} \frac{{λ}_{{t}_{0} - s + 1 + u}^{X} - {λ}_{{t}_{0} - s + u}^{X}}{1 - {λ}_{{t}_{0} - s + 1}^{X}} \cdot {( 1 + i )}^{u} ; & [ 0.32 ] \\ {N}^{X} = {\sum }_{s \leq {t}_{0}} {\tilde{θ}}_{s}^{X} ( {g}_{P , past}^{X} , {i}_{current}^{( res , X )} ) & [ 0.33 ]\end{matrix}$$

and given the reserving inflation rate i_{current}^{(res,X)} and the outstanding claims reserve by line of business (Πₜ_{₀}^{(outst,net)})^{X}.

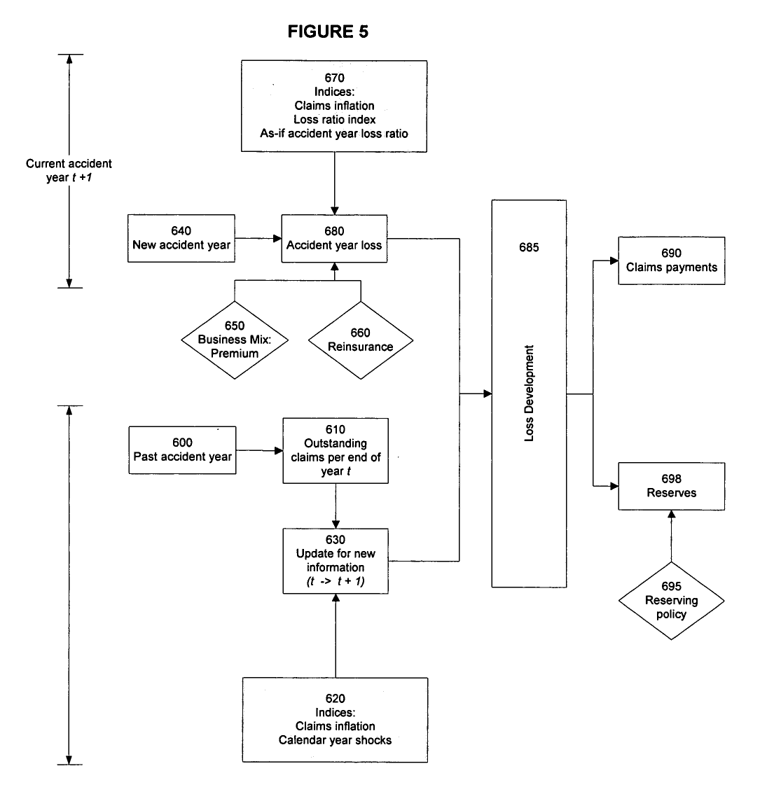

FIG. 5 illustrates the computation steps for the loss process in accordance with one embodiment of the present invention. Past accident years 500 yield outstanding claims per end of year t 510, which is combined with the claims inflation and calendar year shocks indices 520 to form an update 530. New year accident 540, business mix premium 550, reinsurance 560 and claims inflation, loss ratio inflation and as-if accident year loss ratio indices 570 are combined into the accident year loss 580. The accident year loss 580 and the update 530 are combined in the loss development 585, which is used to determine claims payments 590. Loss development 585 is also used together with the reserving policy 595 to determine the reserves 598.

In one embodiment, other technical reserves are not explicitly modelled and are kept at the fixed initial level. Similarly, equalisation reserves are not modelled.

Specify the Strategy

In one embodiment, the user is given some possibilities to specify the initial state and the strategy to be applied in the future. Implicitly included in one embodiment are the changes in premium due to premium rate changes. Therefore, pricing strategies or the expected development on insurance markets is also captured. For a mapping of a pricing strategy the premium growth rate and the loss ratio trend are specified.

Cost cutting strategies are mapped in one embodiment by specifying the underwriting expense ratio trend. However, one embodiment does not allow mapping cost allocation schemes implemented in the real company that, for instance, are designed to minimise tax. By specifying a loss ratio trend one embodiment models shift in the quality of the underwriting portfolio.

Reinsurance

One embodiment restricts on the two most common reinsurance treaties, quota share and excess of loss. The quota share treaty is defined by specifying the quota to be ceded to the reinsurer and the reinsurance commissions received by the insurer. These commissions are a pricing element and are specified in terms of a commission rate πₜ (as a percentage of ceded premium). For the default set-up, one embodiment estimated the quota share from the ratio of net to gross total written premium and the default commission rate from the industry average (default) expense ratio.

The excess of loss reinsurance treaty is defined by the deductible d, the cover c and the number of reinstatements. In one embodiment, the premium paid for the non-proportional treaty is taken proportional to the expected annual loss burden carried by the reinsurer. The expected ceded part of the as-if loss ratio is as follows”

$$\begin{matrix}{P}_{t + 1}^{0} ( c , d ) = E [ \frac{1}{{I}_{t + 1}^{( exposure )}} {\sum }_{j = 1}^{{N}_{t + 1}} min ( c ; max ( 0 ; {X}_{t + 1}^{( j )} \frac{{I}_{t + 1}^{( CI )}}{{I}_{{t}_{0}}^{( CI )}} - d ) ) \vert {I}_{t + 1}^{( CI )} ] \cdot & [ 0.1 ] \\ {( \frac{{I}_{t + 1}^{( CI )}}{{I}_{{t}_{0}}^{( CI )}} )}^{- 1} & \\ = \frac{λ ( t + 1 )}{{I}_{t + 1}^{( exposure )}} \cdot \frac{1}{1 - {( {x}_{0} / {x}_{max} )}^{α}} \cdot & \\ \{ {( \frac{{x}_{0} ( t + 1 )}{{l}_{t + 1}} )}^{α} \cdot [ \frac{α}{α - 1} {l}_{t + 1} - \frac{{I}_{{t}_{0}}^{( CI )}}{{I}_{t + 1}^{( CI )}} d ] + {( \frac{{x}_{0} ( t + 1 )}{{u}_{t + 1}} )}^{α} \cdot & \\ [ \frac{{I}_{{t}_{0}}^{( CI )}}{{I}_{t + 1}^{( CI )}} ( d + c ) - \frac{α}{α - 1} {u}_{t + 1} ] - {( \frac{{x}_{0}}{{x}_{max}} )}^{α} \cdot \frac{{I}_{{t}_{0}}^{( CI )}}{{I}_{t + 1}^{( CI )}} c \} & \\ where & \\ {l}_{t + 1} = max ( {x}_{0} ( t + 1 ) , \frac{d}{{I}_{t + 1}^{( CI )} / {I}_{{t}_{0}}^{( CI )}} ) , {u}_{t + 1} = min ( {x}_{max} ( t + 1 ) , \frac{d + c}{{I}_{t + 1}^{( CI )} / {I}_{{t}_{0}}^{( CI )}} ) & [ 0.2 ]\end{matrix}$$

Assuming infinitely many reinstatements, the premium ceded for the non-proportional reinsurance is then defined to be

$$\begin{matrix}{P}_{t + 1}^{( ced , NP )} = {ϕ}_{t + 1} ( λ , n ) \cdot {P}_{t + 1}^{0} ( {c}_{t + 1} , {d}_{t + 1} ) \cdot & [ 0.3 ] \\ {I}_{t + 1}^{( LR )} \cdot \frac{{I}_{t + 1}^{( CI )}}{{I}_{{t}_{0}}^{( CI )}} \cdot ( 1 - {q}_{t + 1} ) \cdot {P}_{t + 1}^{( earned , gross )} & \\ = {ϕ}_{t + 1} ( λ , n ) \cdot {P}_{t + 1}^{0} ( {c}_{t + 1} , {d}_{t + 1} ) \cdot & \\ {I}_{t + 1}^{( LR )} \cdot \frac{{I}_{t + 1}^{( CI )}}{{I}_{{t}_{0}}^{( CI )}} \cdot ( 1 - {q}_{t + 1} ) \cdot {I}_{t + 1}^{( P , earned )} \cdot {P}_{{t}_{0}}^{( written , gross )} & \end{matrix}$$

The pricing element φₜ includes the users assumptions of what he realistically expects to pay for the non-proportional reinsurance in excess of the expected ceded loss burden given the current and (projected) future market conditions, the discount from buying only a finite number of reinstatements and the discounts from having the ceded claims to be paid at some time lag. In one embodiment, systematic deficiency or excess of reserves is modelled by a suitable reserving inflation rate of a convenient choice for the expected calendar year shock.

Output from Single Line of Business

In one embodiment, all lines of business produce identical output which can easily be aggregated by summing the corresponding contributions of the individual lines of business. Therefore, it is sufficient to specify the generic output of a single line of business as follows:

Cash Flows

Gross/net written premium

Gross/net claims paid

Gross/net expenses paid

Gross/Net Underwriting Cash Flow

= gross/net written premium

− gross/net calendar year claims payments

− gross/net expenses paid

Balance Sheet Positions

Gross/net outstanding claims provisions

Gross/net unearned premium provisions

Other underwriting provisions

Gross/Net Underwriting Reserves

Gross/net deferred acquisition costs (non-trivial only under US-GAAP)

P&L Positions

Gross/Net Earned Premium

= gross/net written premium

− annual change in gross/net unearned premium provision

Gross/Net Incurred Claims

= gross/net claims paid

+ annual change in gross/net outstanding claims provisions

Gross/Net Underwriting Expenses

= gross/net expenses paid

− annual change in gross/net deferred acquisition costs

Gross/Net Underwriting Income:

= gross/net earned premium

− gross/net incurred claims

− gross/net underwriting expenses

Ratios

Gross/Net Loss Ratio

= gross/net incurred claims/gross/net earned premium

Gross/Net Combined Ratio

= (gross/net incurred claims+gross/net underwriting expenses)/gross/net earned premium

In one embodiment, for each of the different valuation principles of interest (such as statutory, US-GAAP, tax, economic for the U.S.) a set of key figures as listed above is produced. In another embodiment, for statutory, tax and economic the deferred acquisition cost is set equal to zero.

Cash Flows

Below is a summary of the most important cash flows in and out of the company in accordance with one embodiment of the present invention. It is structured in form of a flow of cash statement consisting of three parts: operating cash flows Cₜ^{(op)}, cash flows from financing activities Cₜ^{(fin)} and cash flows from investment activities Cₜ^{(inv)}.

Operating Cash Flows

Net Underwriting Cash Flow Cₜ^{(UW,net)}

(aggregated over all lines of business)

Investment Income Cash Flow Iₜ

(aggregated over all investment-portfolios)

Other Income/(Charges) Oₜ

Tax Tₜ

Operating Cash Flows

= Net Underwriting Cash Flow

+ Investment Income Cash Flow

+ Other Income/(Charges)

−−Tax

[symbol]

Cₜ^{op}=Cₜ^{(UW,net)}+Iₜ+Oₜ−Tₜ [0.1]

Cash Flows from Financing Activities

Dividends paid to shareholders Dₜ

Interest expenses (on debt) Xₜ^{(debt)}

Cash from Financing Activities

=−Dividends paid to shareholders

−Interest expenses (on debt)

[symbol]

Cₜ^{(fin)}=−Dₜ−Xₜ^{(debt)} [0.2]

Cash Flow from Investment Activities

Cash flow from sales of investments Cₜ^{(sales)}

Cash flow from maturates Cₜ^{(mat)}

Cash invested in new asset Cₜ^{(new)}

Cash Flow from Investment Activities

= Cash flow from sales of investments

+ Cash flow from maturates

− Cash invested in new asset

[symbol]

Cₜ^{(inv)}=Cₜ^{(sales)}+Cₜ^{(mat)}−Cₜ^{(new)} [0.3]

Liquidity Adjustments

In one embodiment, the cash flows from operating, financing and investment activities are constrained to add up to zero:

Cₜ₊₁^{(op)}+Cₜ₊₁^{(fin)}+Cₜ₊₁^{(inv)}=0. [0.1]

This implies that suitable adjustments are necessary to satisfy this constraint. How to satisfy the constraint [0.1] in accordance with one embodiment of the present invention is described below.

New Investments

In one embodiment, this condition is constrained to zero by allocating available cash to new investments by setting

ΔCₜ₊₁^{(new)}=max(Cₜ₊₁^{(op)}+Cₜ₊₁^{(fin)}+Cₜ₊₁^{(inv)};0). [0.2]

Alternative or additional actions used by other embodiments consist of adjusting the cash flow from financing activities such as increasing the dividend payments to shareholders, buying back shares or paying back debt. This is not considered in one embodiment of the present invention.

In case of Cₜ₊₁^{(op)}+Cₜ₊₁^{(fin)}+Cₜ₊₁^{(sales)}<0 no cash is available for new investments (ΔCₜ₊₁^{(new)}=0) and equation [0.1] is not fulfilled. For instance, this case sometimes occurs when large insurance claims need to be paid and then additional “adjustments” become necessary.

Scope for Adjustments

In one embodiment, financing and investment activities are used to provide the required liquidity. In one embodiment, only investment activities are considered. To summarise, the liquidity is balanced by either purchasing new investments or by liquidating existing ones. In one embodiment, in the latter case, potential tax implications are accounted for.

Additional Sales of Assets

In one embodiment, the operating cash flows are not affected by those adjustments except for taxes which may change according due to additional realised gains. Similarly, the interest on debt position remains unchanged while adjusting the liquidity. All the other cash flow components typically are changed. In order to compute the cash to be liquidated from the investment portfolio one embodiment computes these components given the state of the company just before the adjustment operation:

Taxes:

(Tₜ₊₁)_{before}=t^{tax}·max└(Rₜ₊₁^{tax})_{before},0┘, [0.3]

Cash flow from investment activities: (Cₜ₊₁^{(inv)})_{before},

Cash flow from financing activities:

(Cₜ₊₁^{(fin)})_{before}=−δₜ₊₁^{payout}·max└(Rₜ₊₁)_{before},0┘−rₜ₊₁^{(debt)}·Dₜ^{(debt)}, [0.4]

where the Rₜ₊₁^{tax} is the taxable income and Rₜ₊₁ is the statutory income. The lacking liquidity is given by

ΔUₜ₊₁:=−[(Cₜ₊₁^{(op)})_{before}+(Cₜ₊₁^{(fin)})_{before}+(Cₜ₊₁^{(inv)})_{before}]⁻ [0.5]

In one embodiment, this amount is provided by cash from additional sales of investments corrected by additional tax and dividend payments, i.e.

ΔUₜ₊₁≡ΔCₜ₊₁^{(sales)}−ΔDₜ₊₁−ΔTₜ₊₁ [0.6]

By selling additional assets, additional realised gains are generated which may cause additional tax payments. In one embodiment, additional dividends are paid out in accordance with the simple rule of having a fixed dividend payout ratio. As a consequence, equation [0.5] becomes non-linear due to the non-linear tax and dividend rule. Although a (rather complicated) analytic solution could be written down, one embodiment considers an approximation which constitutes a conservative upper bound.

In one embodiment, the approximation consists in a linearization of the tax and dividend rules. The sales rate applied to investment category “X” for the purpose of cash balancing is denoted by Ωₜ₊₁^{(X,CB)}. As a consequence, the following relations for each asset category are obtained:

The additional cash from sales:

ΔCt+1^{(X,sales)}=Ωₜ₊₁^{(X,CB)}·(Vₜ₊₁^{(X,M)})_{before} [0.7]

the additional (assumed) tax payments:

ΔTₜ₊₁^{(X,CB)}=t^{tax}·Ωₜ₊₁^{(X,CB)}·└(Πₜ₊₁^{(X,UG)})_{before}−(Xₜ₊₁^{(X,depr)})_{before}┘ [0.8]

where (Π^{(X,UG)})_{before} is the unrealised gains reserve of investment category “X” just before the liquidity adjustment and (X^{(X,depr)})_{before} denotes the depreciation expense associated with the investment category “X.” In one embodiment for the U.S., the last term with the depreciation expense is zero.

The additional (assumed) dividend payments:

ΔDₜ₊₁^{(X,CB)}=δₜ₊₁^{payout}·Ωₜ₊₁^{(X,CB)}·└(Πₜ₊₁^{(X,UG)})_{before}−(Xₜ₊₁^{(X,depr)})_{before}┘·(1−t^{tax}). [0.9]

Then, equation [0.5] becomes linear in the additional sales rates Ωₜ₊₁^{(X,CB)}:

$$Δ {U}_{t + 1} = {\sum }_{X} {Ω}_{t + 1}^{( X , CB )} \cdot {L}_{t + 1}^{( X )} \qquad [ 0.10 ]$$

with

Lₜ₊₁^{(X)}={(Vₜ₊₁^{(X,M)})_{before}−(δₜ₊₁^{payout}+t^{tax}·(1−δₜ₊₁^{payout}))·(Πₜ₊₁^{(X,UG)})_{before}−(δₜ₋₁^{payout}+t^{tax}(1−δₜ₊₁^{payout}))·(Xₜ₊₁^{(X,depr)})_{before}} [0.11]

With weight factors ζₜ₊₁^{bonds}, ζₜ₊₁^{eq}, ζₜ₊₁^{others} satisfying ζ₊₁^{bonds}+ζₜ₊₁^{eq}+ζₜ₊₁^{others}=1 one embodiment specifies from which asset class to take, if possible, the needed liquidity:

(ΔCₜ₊₁^{(X,sales)})⁽⁰⁾=min(ζₜ₊₁^{X}·ΔU_{t+1·(}Vₜ₊₁^{(X,M)})_{before}/Lₜ₊₁^{(X)},(Vₜ₊₁^{(X,M)})_{before}) [0.12]

In case this is not sufficient one embodiment takes the rest from selling investments in proportion to their market value. With

$${( Δ {C}_{t + 1}^{( sales )} )}^{( 0 )} = {\sum }_{X}^{} {( Δ {C}_{t + 1}^{( X , CB )} )}^{( 0 )} \qquad [ 0.13 ]$$

the embodiment sets

$$Δ {C}_{t + 1}^{( X , sales )} = {( Δ {C}_{t + 1}^{( X , sales )} )}^{( 0 )} + \frac{{( {V}_{t + 1}^{( X , M )} )}_{before} - {( Δ {C}_{t + 1}^{( X , sales )} )}^{( 0 )}}{{\sum }_{X} [ {( {V}_{t + 1}^{( X , M )} )}_{before} - {( Δ {C}_{t + 1}^{( X , sales )} )}^{( 0 )} ]} \cdot \{ Δ {U}_{t + 1} - {( Δ {C}_{t + 1}^{( sales )} )}^{( 0 )} \} \qquad [ 0.14 ]$$

and, in case of (Vₜ₊₁^{(X,M)})_{before}>0,

Ωₜ₊₁^{(X,CB)}=ΔCₜ₊₁^{(X,sales)/(}Vₜ₊₁^{(X,M)})_{before}. [0.15]

In extremely adverse situations the liquidity balance may still not be satisfied by the above procedure. For instance, this may happen in cases where the company under consideration needs to pay claims larger than the market value of investments. In this case, the balance sheet is not being balanced any longer. One embodiment of the present invention is not set-up to adequately reflect such situations. Additionally situations where the company starts to see solvency problems is not well reflected since the supervision by the authority is not modelled in one embodiment.

Accounting and Tax

Only U.S. standards are available within one embodiment of the present invention. Another embodiment is designed to accommodate accounting and statutory calculations in Europe. In one embodiment, accounting is treated approximately. The calculations used for the approximate P&L statement and the balance sheet are specified below.

Balance Sheet

Assets

Investments

Cash & Deposits

Bonds & Fixed Income Securities

Equities

Other Investments

Debtors, Receivables

Deferred acquisition costs net of reinsurance

Other

Other Assets

Liabilities

Surplus

Share Capital

Other Surplus

Revaluation Reserve

Profit&Loss, Retained Earnings

Technical reserves

Outstanding claims provisions

Unearned premium provisions

Equalization provisions

Other technical provisions

Other Liabilities

External borrowings, debt

evt. deferred tax

Other liabilities

The basic assumptions made for the balance sheet entries in accordance with one embodiment of the present invention are summarized in the table below.

| | | US-GAAP | US Statutory | US Tax |
|---|---|---|---|---|
| A1 | Valuation of bonds | at amortized cost | at amortized cost | at amortized cost |
| | | (‘held to maturity’) | | |
| A2 | Valuation of equities | at market value and | at market value and | at market value and |
| | | difference between | difference between | difference between |
| | | market value and | market value and | market value and |
| | | purchase value | purchase value | purchase value |
| | | reflected in the | reflected in the | reflected in the |
| | | revaluation reserve | revaluation reserve | revaluation reserve |
| | | (‘available for | | |
| | | sales’) | | |
| A3 | Valuation of other | at purchase value | at purchase value | at purchase value |
| | investments | | | |
| A4 | DAC | 20% of unearned | none | none |
| | | premium | (acquisition costs | (acquisition costs |
| | | | expensed in year of | expensed in year of |
| | | | occurrence) | occurrence) |
| A5 | Other Assets | Not explicitly modeled, kept constant at initial level. | | |
| L1 | Capital | Not explicitly modeled, kept constant at | | |
| | | initial level. | | |
| L2 | Retained earnings, | The cumulated | The cumulated | |
| | Profit & Loss | retained GAAP | retained statutory | |
| | | earnings after tax. | earnings after tax. | |
| L3 | Revaluation reserve | Unrealized Gains of | Unrealized Gains of | |
| | | ‘available for sales | the equities | |
| | | assets’ less taxable | | |
| | | part. | | |
| L4 | Other Surplus | None | None | |
| L5 | Outstanding Claims | On a nominal basis; | On a nominal basis; | On a discounted |
| | Provisions | the gross reflected | net of reinsurance; | basis, discounted |
| | | on liability side and | anticipated future | with a 5y zero yield |
| | | the ceded portion | claims inflation | (as obtained from |
| | | reflected on the | included (reserving | the interest |
| | | asset side of the | inflation rate) | generator); |
| | | balance sheet; | | net of reinsurance; |
| | | anticipated future | | anticipated future |
| | | claims inflation | | claims inflation |
| | | included (reserving | | included (reserving |
| | | inflation rate) | | inflation rate) |
| L6 | Unearned Premium | on a net basis; | on a net basis; | on a net basis; |
| | Provisions | percentage of | percentage of | percentage of |
| | | written premium. | written premium. | written premium |
| | | | | reduced by factor |
| | | | | (1 − ω₁), where |
| | | | | ω₁ = 20%. |

| L7 | Other Underwriting | The cumulated retained earnings after tax. | |
|---|---|---|---|
| | Reserves | | |
| L8 | Debt | Kept constant at initial level. | |
| L9 | Deferred tax | Taxable part of the | none |
| | | unrealized capital | |
| | | gains included in | |
| | | the revaluation | |
| | | reserve | |

| | | |
|---|---|---|
| L10 | Other Liabilities | Not explicitly modeled, kept constant at initial level. |

In one embodiment, if the user modifies the balance sheet entries for the initial year (t₀) the “Other Assets” and “Other Liabilities” are adjusted such that the balance sheet is balanced again.

Income Statement

Underwriting Account

Net earned premium

[gross earned premium−ceded earned premium]

−Net claims paid

[gross claims paid−ceded claims paid]

−Change in provisions for outstanding claims

[change in gross provisions−change in ceded provisions]

−Change in other technical reserves (≡0)

−Net expenses incurred

[direct expenses incurred−ceded expenses incurred]

+Investment Income

+Realized capital gains

−Interest expenses

−Other income/(Charges)

−Taxes

Profit After Tax

−Dividends Paid to Shareholders

+Adjustments

Retained Profit for the Financial Year

In one embodiment, some positions on the balance sheet such as “goodwill” are assumed to be constant over the simulation horizon so that there is, for instance, no goodwill amortization in the income statement. If a particular item (such as “goodwill”) is not included in the “generic” balance sheet presented above, it should be interpreted as included in the “Other Assets” or “Other Liabilities” position.

In one embodiment, the “Retained Earnings” are updated by accumulating the “Retained Earnings for the Financial Year.” In another embodiment, taxes are computed from taxable income according to the formula:

Tₜ₊₁=τ·max(0,(Rₜ₊₁)_{USTax}) [0.1]

where the taxable income is obtained from an income statement of a form using balance sheet positions in accordance with US Tax accounting (unearned premium provisions and outstanding claims provisions) and weighting the investment income from stock investments to only 30%.

In one embodiment, the dividends paid to the shareholders of the company are calculated form the statutory earnings after tax according to the formula:

Dₜ₊₁=δₜ₊₁^{payout}·mal (0,(Rₜ₊₁)ₐₜ^{statut}) [0.2]

where (Rₜ₊₁)ₐₜ^{statut} is the statutory earnings after tax and δₜ₊₁^{payout}, the dividend payout ratio, is assumed to be constant over the simulation horizon. In another embodiment, adjustments are not explicitly modeled.

As a further key figure which can be used to characterize the solvency of the company one embodiment introduces the solvency ratio defined by the ratio of the statutory surplus divided by net earned premium. In another embodiment, the return on equity is computed as the earnings after tax divided by the previous years' surplus.

Thus, a method and apparatus for public information dynamic financial analysis is described in conjunction with one or more specific embodiments. The invention is defined by the following claims and their full scope and equivalents.

1. A method of analyzing financial information comprising:
retrieving a set of user-accessible information for a company from a database; and
performing a dynamic financial analysis for said company using said set.

2. The method of claim 1 wherein said step of performing is performed automatically.

3. The method of claim 1 wherein said step of retrieving is performed automatically.

4. The method of claim 1 wherein said step of retrieving comprises:
transforming a data item into a desired format from said set wherein said data item is not available in said desired format in said set.

5. The method of claim 1 wherein said step of retrieving comprises:
using a proxy data item when said data item is not available or not usable.

6. The method of claim 1 wherein said step of retrieving comprises:
issuing a request for said set by a means for displaying data.

7. The method of claim 6 wherein said means for displaying data is a web browser.

8. The method of claim 1 wherein said set of user-accessible information is a set of public information.

9. A financial information analyzer comprising:
an information retrieval unit configured to retrieve a set of user-accessible information for a company from a database; and
an analyzer configured to perform a dynamic financial analysis for said company using said set.

10. The financial information analyzer of claim 9 wherein said analyzer is further configured to perform automatically.

11. The financial information analyzer of claim 9 wherein said information retrieval unit is further configured to retrieve automatically.

12. The financial information analyzer of claim 9 wherein said information retrieval unit comprises:
an extractor configured to transform a data item into a desired format from said set wherein said data item is not available in said desired format in said set.

13. The financial information analyzer of claim 9 wherein said information retrieval unit comprises:
a proxy unit configured to use a proxy data item when said data item is not available or not usable.

14. The financial information analyzer of claim 9 wherein said information retrieval unit comprises:
a request issuing unit configured to issue a request for said set.

15. The financial information analyzer of claim 14 wherein said request is issued by a web browser.

16. The financial information analyzer of claim 9 wherein said set of user-accessible information is a set of public information.

17. The computer program product comprising:
a computer usable medium having computer readable program code embodied therein configured to analyze financial data, said computer program product comprising:
computer readable code configured to cause a computer to retrieve a set of public information for a company from a database; and
computer readable code configured to cause a computer to perform a dynamic financial analysis for said company using said set.

18. The computer program product of claim 17 wherein said computer readable code configured to cause a computer to perform is further configured to cause a computer to perform automatically.

19. The computer program product of claim 17 wherein said computer readable code configured to cause a computer to retrieve is further configured to cause a computer to retrieve automatically.

20. The computer program product of claim 17 wherein said computer readable code configured to cause a computer to retrieve comprises:
computer readable code configured to cause a computer to transform a data item into a desired format from said set wherein said data item is not available in said desired format in said set.

21. The computer program product of claim 17 wherein said computer readable code configured to cause a computer to retrieve comprises:
computer readable code configured to cause a computer to use a proxy data item when said data item is not available or not usable.

22. The computer program product of claim 17 wherein said computer readable code configured to cause a computer to retrieve comprises:
computer readable code configured to cause a computer to issue a request for said set.

23. The computer program product of claim 22 wherein said request is issued by a web browser.

24. The computer program product of claim 17 wherein said set of user-accessible information is a set of public information.
